(19) United States
(12) Patent Application Publication
(10) Pub. No.: US 2026/0162122 A1
(43) Pub. Date: Jun. 11, 2026

(54) PROCESSING OF MULTIPLE BENEFITS AVAILABLE FOR RETAIL PURCHASES EMPLOYING A GAMING ESTABLISHMENT ACCOUNT AND A LINKED FINANCIAL INSTITUTION ACCOUNT

(71) Applicant: IGT, Las Vegas, NV (US)

(72) Inventors: Kevin Higgins, Reno, NV (US); Jeffery Shepherd, Reno, NV (US)

(21) Appl. No.: 18/975,749

(22) Filed: Dec. 10, 2024

(51) Int. Cl. G06Q 20/40; G06Q 20/38

(52) U.S. Cl. CPC G06Q 20/403; G06Q 20/387

(57) ABSTRACT

Systems and methods that, responsive to a plurality of discounts being available and a receipt of data associated with a purchase transaction associated with a first amount of funds that is initiated at a point-of-sale terminal in association with a dedicated bank account associated with a gaming establishment account, select a discount from the plurality of discounts, apply, to the purchase transaction, the selected discount, and enable the purchase transaction to be completed for a second amount of funds that is less than the first amount of funds. Responsive to no discounts being available and the receipt of data associated with the purchase transaction associated with the first amount of funds that is initiated at the point-of-sale terminal in association with the dedicated bank account associated with a gaming establishment account, the systems and methods enable the purchase transaction to be completed for the first amount of funds.

### BACKGROUND

In various embodiments, responsive to a plurality of discounts being available and a receipt of data associated with a purchase transaction associated with a first amount of funds that is initiated at a point-of-sale terminal in association with a dedicated bank account associated with a gaming establishment account, the systems and methods of the present disclosure select a discount from the plurality of discounts, apply, to the purchase transaction, the selected discount, and enable the purchase transaction to be completed for a second amount of funds that is less than the first amount of funds.

Casinos are associated with multiple different channels of commerce including gaming activities (e.g., wagers on plays of games at electronic gaming machines and gaming tables) and non-gaming activities (e.g., making retail purchases at point-of-sale terminals throughout the casino).

### BRIEF DESCRIPTION OF THE SEVERAL VIEWS OF THE DRAWINGS

FIG. 1 is an example configuration of the architecture of a plurality of different components of the system of the present disclosure.

FIG. 2 is a flow chart of an example process for operating a system which enables, for a purchase transaction, a transfer of funds between a retail system and an enterprise electronic wallet system associated with a dedicated bank account linked to a gaming establishment fund management system account and which communicates certain retail rating information associated with the purchase transaction.

FIG. 3 is a visual representation of an example of retail rating information communicated from the enterprise electronic wallet system to a gaming establishment patron management system in association with a purchase transaction and utilized to potentially obtain one or more benefits.

FIG. 4 is a flow chart of an example process for operating a system which enables, for a purchase transaction, an application of a discount and a subsequent transfer of funds between a retail system and an enterprise electronic wallet system associated with a dedicated bank account linked to a gaming establishment fund management system account.

### DETAILED DESCRIPTION

In various embodiments, responsive to a plurality of discounts being available and a receipt of data associated with a purchase transaction associated with a first amount of funds that is initiated at a point-of-sale terminal in association with a dedicated bank account associated with a gaming establishment account, the systems and methods of the present disclosure select a discount from the plurality of discounts, apply, to the purchase transaction, the selected discount, and enable the purchase transaction to be completed for a second amount of funds that is less than the first amount of funds.

In certain embodiments, the system of the present disclosure dedicates or otherwise integrates a financial institution account associated with a financial institution, such as a bank account associated with a banking institution, with one or more gaming establishment accounts maintained by a gaming establishment fund management system, such as a cashless wagering account maintained by a cashless wagering system. In these embodiments, the dedicated financial institution account, such as a checking account, is associated with a payment instrument used in the banking industry, such as a debit card operable with a network payment processor, to enable financial transactions remote and independent from any gaming establishments. In addition to accessing, in association with a retail transaction, an amount of funds held in a dedicated financial institution account associated with a user, the system of the present disclosure offers one or more benefits to the user in association with such access. Accordingly, without imposing any external financial institution account transfer delays, the system utilizes a dedicated financial institution account (e.g., a gaming checking account) to operate as a gateway to potentially access, in real time and in association with the procurement of certain additional benefits, funds that previously were maintained in a gaming establishment account (e.g., a user's cashless wagering account) and were subject to various delays in the movement of such funds to and from the gaming establishment account.

In certain embodiments, following the integration (or otherwise creation) of a dedicated financial institution account maintained by a financial institution with one or more gaming establishment accounts maintained by a gaming establishment fund management system, the system of the present disclosure offers one or more benefits in association with the use of a payment instrument, such as a debit card, issued by the financial institution that is linked with the dedicated financial institution account. In these embodiments, in association with a purchase transaction occurring at a retailer, if that purchase transaction involves the transfer of funds from the dedicated financial institution account, the system invokes one or more benefits as part of and/or subsequent to the purchase transaction. In certain such embodiments, the system delivers the benefit after the purchase transaction, such as crediting the gaming establishment account with an amount of funds based on the purchase transaction and/or crediting a gaming establishment patron management system account with an amount of gaming establishment currency based on the purchase transaction. In other such embodiments, the system delivers the benefit in association with the purchase transaction, such as invoking the use of one or more discounts to apply toward the purchase transaction. In these different embodiments, the employment of one or more benefits, such as one or more present or future discounts at a retail establishment not otherwise available, for utilizing a dedicated financial institution account associated with a gaming establishment account extends the reach of a gaming establishment loyalty program beyond the gaming establishment while furthering the relationship between the gaming establishment and one or more retail establishments.

In certain embodiments in which the application of any discount (i.e., a benefit) occurs contemporaneously with the occurrence of the purchase transaction, upon one or more components of the system receiving a request for a purchase transaction occurring at a component of a retail establishment, such as a point-of-sale terminal at a retail establishment affiliated with a gaming establishment, the system of the present disclosure determines whether or not to apply any available discounts in association with the purchase transaction. In certain embodiments, the system is preconfigured to apply discounts to qualifying retail establishments in association with purchase transactions occurring at the retail establishment such that the system automatically notifies a component of the retail establishment to apply the discount, such as by modifying a purchase price of the goods and/or services associated with the purchase transaction. In other embodiments, the system operates with a component of a gaming establishment patron management system to access one or more discounts available to a user. In these embodiments, the system determines, with or without any user input, one or more available discounts to apply and notifies a component of the retail establishment to apply the determined discounts, such as by modifying a purchase price of the goods and/or services associated with the purchase transaction.

Following any application of an available discount (or if a determination occurs not to apply any discounts), the system of the present disclosure determines whether or not to complete the purchase of the goods and/or services attempted to be purchased as part of the purchase transaction. In such embodiments, this determination is based on the amount of funds held in a dedicated financial institution account associated with a user (but, in certain instances, displayed to the user as being held in a gaming establishment account, such as a cashless wagering account, maintained for that user) relative to the purchase price (with or without the application of any available discounts to the purchase price). If the system denies the purchase (with or without the application of any discounts), the system notifies the point-of-sale terminal to deny the attempted purchase transaction. That is, if the determination is to not complete the attempted purchase transaction, such as for lack of funds in the dedicated financial institution account, the purchase transaction is denied without any fund transfers and further without the redemption or application of any discounts. Conversely, if the system approves the purchase (with or without the application of any discounts), the system causes (or otherwise requests a component that maintains the dedicated financial institution account to cause) a transfer of an amount of funds associated with the approved purchase from the dedicated financial institution account to an account associated with the retail establishment and further notifies the point-of-sale terminal to complete the attempted purchase transaction. Such a configuration enables discounting to be offered, in real time, for purchases made using a payment instrument of a financial institution account associated with a gaming establishment account. Such a configuration further enables funds to be accessed using a payment instrument issued by a financial institution without requiring a user to first make one or more inputs to transfer any funds from a gaming establishment account to any separate account and further without the need to wait for any fund transfer to be completed (or alternatively pay various surcharge fees to expedite any fund transfers).

In operation of certain embodiments in which the retail transaction is a purchase transaction, the delivery of any benefit occurs following the occurrence of the retail transaction. In these embodiments, following the completion of the purchase transaction using, as described above, a payment instrument to access funds in a financial institution account associated with a gaming establishment account, the system communicates data associated with the completed purchase transaction to a component of a gaming establishment system, such as a component of a gaming establishment patron management system and/or a component of a separate benefit management system. For example, following the completion of a purchase transaction, the system communicates a retail rating including data on the location of the purchase, the date/time of the purchase, the amount of the purchase and an identifier of a user whom made the purchase, to a player tracking system server (i.e., a component of a gaming establishment patron management system). In certain embodiments, employing the data associated with the completed purchase transaction, the component of the gaming system determines whether to issue any benefit in association with the completed purchase transaction. Continuing with the above example, the player tracking system server utilizes the data associated with the completed purchase transaction to add an amount of player tracking points to a player tracking account of an identified user whom made the purchase. In another example, a gaming establishment fund management system server utilizes the data associated with the completed purchase transaction to associate a coupon for a future purchase with an identified user whom made the purchase and/or add an amount of funds to the gaming establishment account associated with the financial institution account. Such a configuration of offering post-transaction benefits with future redemption opportunities for purchases made using a payment instrument of a dedicated financial institution account associated with a gaming establishment account extends the engagement duration between the user and the gaming establishment (and/or one or more affiliated gaming establishment partners).

As mentioned above, unlike prior payment solutions in which if a user wants to access their funds held in a casino account at a retail establishment outside of the casino, the user needs to first transfer their funds to an external bank account (after which the user can then pay at that retail establishment outside of the casino using a debit card or credit card associated with their external bank account), or alternatively first transfer their funds to an external electronic wallet (after which the user can use a pre-paid debit card associated with their external electronic wallet to pay at that retail establishment outside of the casino), the employment of the dedicated bank account (with the incorporation of certain additional benefits as part of the transaction and/or the issuance of certain additional benefits upon completion of the transaction) enables the user to avail themselves of the use of a payment instrument, such as a debit card, for purchases made outside of the casino while still having funds readily available for use within the casino.

Accordingly, in certain embodiments, the system of the present disclosure enables funds that previously were not immediately accessible outside of a casino to become accessible (with the incorporation of certain additional benefits as part of the transaction and/or the issuance of certain additional benefits upon completion of the transaction) via a payment instrument associated with a dedicated bank account (that is dedicated to the user, associated with the user's gaming establishment account and remains owned by the system of the present disclosure). In these embodiments, by associating a gaming establishment account maintained for a user, a bank account dedicated to the user and linked to the gaming establishment account and an electronic wallet (e.g., a financial transaction application that runs on a mobile device and securely stores payment information, such as debit card information, and passwords to enable the payment of goods and/or services), the system of the present disclosure operates to enable benefits to be procured while funds flow between different verticals quicker than previously available. In other words, by integrating a bank account created in association with the system directly with one or more gaming establishment accounts, the present disclosure enables a payment instrument associated with the dedicated bank account to function as an interface (and a benefit driving engine) to access funds independent of any involvement of any other external accounts that require a relatively extended period of time to transfer funds to. In addition to realizing certain benefits associated with a purchase transaction, such a configuration enables a user to access the network payment processors accessible with certain payment instruments, such as debit cards, without first needing to transfer any amounts of funds from a gaming establishment account to an external account associated with the debit card to gain such access. Such a configuration additionally saves users time (e.g., no time needs to be spent transferring funds from a gaming establishment account to an external banking account associated with a debit card or waiting a dedicated amount of time for such a transfer to be completed) and offers operational efficiencies (e.g., reducing the number of touchpoints funds must flow through before they may be used) compared to prior payment solutions involving funds in a casino account.

It should be appreciated that prior systems that did not offer any benefits, required one or more inputs to transfer funds in a gaming establishment account to an external financial institution account associated with a debit card and further required a certain amount of time, such as up to three days, for the transfer to be completed and the transferred funds to become available using a debit card. Unlike such prior systems, the system of present disclosure offers one or more benefits as part of the transaction and/or upon completion of the transaction, bypasses the prolonged transfer periods (and in doing so further bypasses the need for the external financial institution account previously employed) and enables the system to interact, in real time, with various non-gaming establishment components such that the funds that otherwise would have to be maintained in a gaming establishment account are available, via the employment of the dedicated bank account, for immediate use at a non-gaming device (via employing a payment instrument associated with such an account as a gateway to such funds). As such, in addition to realizing certain benefits associated with a purchase transaction, the system of the present disclosure offers the advantages of bank account transactions without the fund transfer friction and timing restrictions previously encountered in moving funds from a gaming establishment account, thereby providing the user greater control over their funds.

Accordingly, in view of the different channels of commerce available both in association with and independent of one or more gaming establishments, the system offers a dedicated bank account that enables access to funds in different channels of commerce associated with or independent of one or more gaming establishments. Such transfers thus reduce the fund movement friction encountered in using funds otherwise held in a gaming establishment account to complete transactions outside of the gaming establishment network while still realizing the benefits of network payment processors offered by the use of payment instruments associated with the dedicated bank account. Such a configuration further facilitates, amongst other benefits, a more cashless environment (e.g., cash does not need to be withdrawn from a gaming establishment account and then brought to a retailer, either internal to or external from the gaming establishment, to purchase goods and/or services) which increases safety (e.g., minimizing users having to carry large sums of cash associated with large sums of money and minimizing such cash being a vehicle to spread potentially harmful contagions).

In various embodiments, the present disclosure is directed to a system, such as a gaming establishment fund management system, including various sub-systems that are each associated with or otherwise maintain one or more electronic or virtual accounts. In these embodiments, the various accounts maintained for a user individually or collectively form a resort or enterprise account (i.e., a gaming establishment fund management account) for the user. That is, the collection of cashless wagering accounts (e.g., cashless gaming establishment wagering wallets, cashless sports wagering wallets and/or cashless mobile wagering wallets) and gaming establishment retail accounts (e.g., gaming establishment retail wallets) associated with or otherwise maintained for a user, such as a retail patron, individually or collectively form a resort or enterprise account (i.e., an integrated resort or gaming establishment fund management wallet) that the user may access to transfer funds and/or view balance information amongst the various accounts associated with or otherwise maintained for the user.

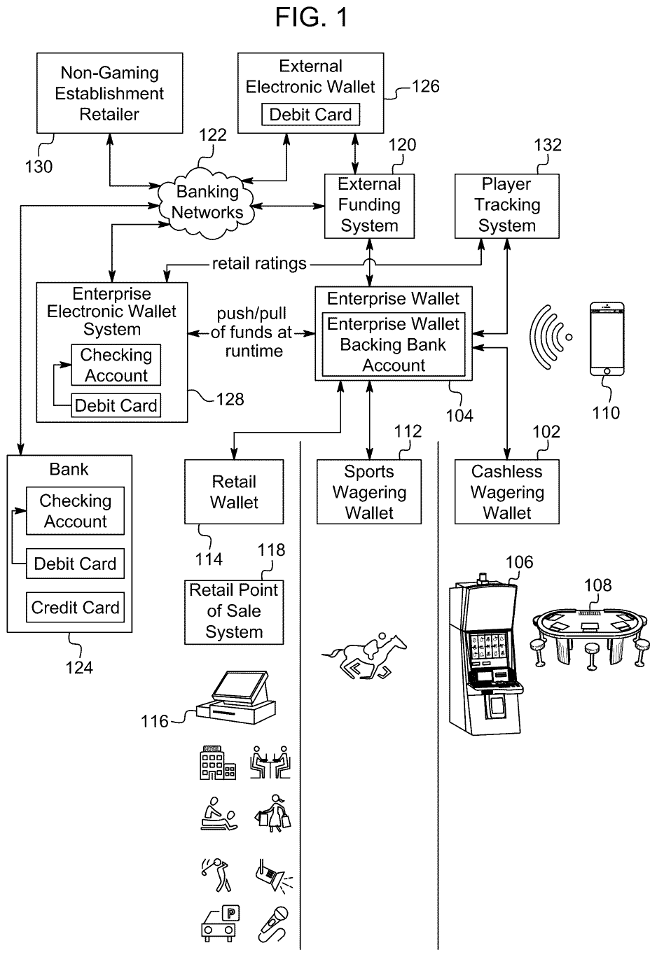

In various embodiments, the gaming establishment fund management system includes or is otherwise associated with one or more cashless wagering systems. Each cashless wagering system is associated with or otherwise maintain one or more cashless wagering accounts. In certain embodiments, the gaming establishment fund management system includes a first cashless wagering system that maintains a first cashless wagering account. In these embodiments, a user, such as a player of an electronic gaming machine (“EGM”), utilizes a mobile device application running on a mobile device and/or a physical instrument (e.g., a smart card or a user issued magnetic striped card which the user utilizes via inserting the card into a card reader associated with the EGM) to facilitate the electronic transfer of any funds between this first cashless wagering account and a gaming device, such as a component of a gaming table and/or an EGM (including, but not limited to, a slot machine, a video poker machine, a video lottery terminal, a terminal associated with an electronic table game, a terminal associated with a live table game, a video keno machine, a video bingo, and/or a sports betting terminal (that offers wagering games and/or sports betting opportunities)). For example, as seen in FIG. 1, the gaming establishment fund management system includes a first cashless wagering system (not shown) that maintains a Cashless Wagering Wallet 102 (e.g., a first cashless wagering account) which is in communication with the enterprise wallet 104. In this example, to facilitate the transfer of funds between this cashless wagering account and a credit balance of an EGM 106 and/or a credit balance of a gaming table component (not shown) associated with a gaming table 108, the system utilizes a mobile device 110 running a mobile device application that interfaces with one or more components of the gaming establishment fund management system to enable a user, such as a player of the EGM or a player at the gaming table, access to this first cashless wagering account.

In certain embodiments, the gaming establishment fund management system additionally or alternatively includes or is otherwise associated with a second cashless wagering system that maintains a second cashless wagering account. In these embodiments, funds associated with the second cashless wagering account are utilized to place one or more sporting event wagers and/or wagers placed remote from an EGM and a gaming table. In such embodiments, a user utilizes a mobile device application running on a mobile device and/or a physical instrument (e.g., a smart card or a user issued magnetic striped card which the user utilizes via inserting the card into a kiosk) to facilitate the electronic transfer of any funds between this second cashless wagering account and a credit balance accessible to wager on sporting events and/or games of chance (or games of skill) remote from an EGM and a gaming table. For example, as seen in FIG. 1, the gaming establishment fund management system includes a second cashless wagering system (not shown) that maintains a Sports Wagering Wallet 112 (e.g., a second cashless wagering account) which is in communication with the enterprise wallet 104. In this example, to facilitate the transfer of funds between this cashless wagering account and a credit balance associated with a sporting event wagering system (not shown) and/or a remote wagering system (not shown) to enable the placement of one or more wagers on one or more sporting events and/or one or more games of chance (or games of skill), the system utilizes a mobile device 110 running a mobile device application that interfaces with one or more components of the gaming establishment fund management system to enable, amongst other activities, a user, such as a user remote from the gaming establishment, access to this second cashless wagering account.

In various embodiments, in addition to or an alternative of maintaining one or more cashless wagering accounts via one or more cashless wagering systems, the gaming establishment fund management system includes or is otherwise associated with one or more gaming establishment retail wallet systems that each maintain one or more gaming establishment retail accounts. In certain embodiments, such a gaming establishment retail account (e.g., a gaming establishment retail wallet) of a gaming establishment retail wallet system integrates with various retail point-of-sale systems throughout the gaming establishment (or located remote from the gaming establishment, but otherwise associated with the gaming establishment) to enable users to purchase goods and/or services via the user's gaming establishment retail account. For example, as seen in FIG. 1, the gaming establishment fund management system includes a gaming establishment retail wallet system (not shown) that maintains a Retail Wallet 114 (e.g., a gaming establishment retail account) which is in communication with the enterprise wallet 104. In this example, to facilitate the transfer of funds between this gaming establishment retail account and an account associated with a gaming establishment retailer to purchase goods and/or services from the gaming establishment retailer, the system utilizes a retail wallet identity, such as a mobile device 110 running a mobile device application that interfaces with a point-of-sale terminal 116 of a retail point-of-sale system 118 of the gaming establishment retailer and/or a physical instrument (e.g., a smart card or a user issued magnetic striped card which the user utilizes in association with the point-of-sale terminal), and one or more components of the gaming establishment fund management system to enable a user access to this gaming establishment retail account. In other embodiments, the gaming establishment fund management system does not maintain a separate gaming establishment retail account, but rather utilizes the gaming establishment retail wallet system as a transaction coordinator to account for any transactions to purchase goods and/or services from a gaming establishment retailer.

In certain embodiments, a gaming establishment retail account is a retail account associated with a user having a balance or a pre-paid access account which, per current regulations from the U.S. Treasury Department Financial Crimes Enforcement Network (“FinCEN”), cannot be convertible to cash and can only be used for the purchase of goods and/or services. In these embodiments, such a gaming establishment retail account integrates with various retail point-of-sale systems of various retail establishments throughout or otherwise associated with a gaming establishment to enable users to purchase goods and/or services via the user's gaming establishment retail account. Accordingly, in certain embodiments, based on one or more jurisdictional regulations, an amount of funds deposited in a gaming establishment retail account may be used with various retail point-of-sale systems throughout the gaming establishment (or remote from, but otherwise associated with the gaming establishment) to enable users to purchase goods and/or services, but such funds deposited in the gaming establishment retail account cannot be converted to cash or check. In certain other embodiments, based on one or more different jurisdictional regulations, an amount of funds deposited in a gaming establishment retail account, such as an account associated with an identified user, may be used with various retail point-of-sale systems throughout the gaming establishment (or remote from, but otherwise associated with the gaming establishment) to enable users to purchase goods and/or services wherein such funds deposited in the gaming establishment retail account may be converted to or otherwise redeemable for cash or check.

In various embodiments, one or more of the accounts of the gaming establishment fund management system are associated with one or more backing bank accounts. In these embodiments, since certain regulations require that at least the funds held in association with one or more of the accounts of the gaming establishment fund management system be held in a financial institution account associated with the gaming establishment fund management system, the system of the present disclosure employs one or more of such backing bank accounts (to ensure compliance with applicable regulations) and further operates with one or more financial institutions to periodically reconcile the funds in such a backing bank account to reflect fund transfers associated with one or more accounts maintained by the gaming establishment fund management system. For example, as seen in FIG. 1, the enterprise wallet 104 maintained by the gaming establishment fund management system is associated with an enterprise wallet backing bank account that the gaming establishment fund management system operates with a component of a financial institution that maintains such a backing bank account to automatically move (or move responsive to commands from appropriate personnel) funds into and out of based on transactions made against the accounts maintained by the gaming establishment fund management system. It should be appreciated that while the enterprise wallet of this illustrated example is associated with an enterprise wallet backing bank account, any other account maintained by the system of the present disclosure, such as the illustrated first cashless wagering account, the illustrated second cashless wagering account and/or the illustrated gaming establishment retail account, may additionally or alternatively be associated with a backing bank account.

In certain embodiments, the gaming establishment fund management system includes or is otherwise in communication with one or more external funding sources which maintain one or more external accounts for the user. For example, as seen in FIG. 1, the gaming establishment fund management system that maintains the enterprise wallet 104 is in communication with an external funding system 120 which is in communication with a network of one or more banks or other financial institutions (i.e., the banking network 122) which operate to electronically transfer funds between the user's accounts maintained at such banks or financial institutions (i.e., bank 124 maintaining an external checking account associated with a debit card and/or a credit card) and one or more of the accounts maintained by the gaming establishment fund management system. As further seen in FIG. 1, in this example, the external funding system 120 is in communication (directly or indirectly via banking network 122) with an external electronic wallet 126 associated with a debit card, such as a pre-paid debit card, which operates to electronically transfer funds between the user's external electronic wallet and one or more of the accounts maintained by the gaming establishment fund management system. In certain embodiments, funds maintained in the accounts of the external funding sources may be transferred to and/or from one or more accounts maintained by the gaming establishment fund management system. These accounts of the external funding sources include, but are not limited to, one or more external checking accounts maintained by one or more financial institutions (e.g., one or more banks and/or credit unions), one or more external savings accounts maintained by one or more financial institutions, one or more external financial institution accounts, such as a brokerage account, maintained by one or more financial institutions, one or more external credit card accounts maintained by one or more financial institutions, one or more external debit card accounts maintained by one or more financial institutions, and/or one or more external third-party maintained accounts (e.g., one or more PayPal® accounts or Venmo® accounts). It should be appreciated that while illustrated as the gaming establishment fund management system being in communication with one or more external funding sources, in different embodiments, any system or sub-system of the present disclosure can be in communication with one or more external funding sources. In different embodiments, the system utilizes a mobile device running a mobile device application, a kiosk, a gaming device (e.g., an interface of an EGM or gaming table component), a service window displayed by a gaming device (e.g., a remote host controlled service window displayed by an EGM), a component of a gaming establishment patron management system, such as a player tracking unit, and/or a gaming establishment interface to facilitate the transfer of funds to/from an external account.

In certain embodiments, the gaming establishment fund management system includes or is otherwise associated with an enterprise electronic wallet system. In these embodiments, the enterprise electronic wallet system operates to open, be associated with or otherwise own one or more dedicated bank accounts on behalf of a user. In certain embodiments, the enterprise electronic wallet system opened bank account is associated with one or more debit cards for a user (which are independent of any debit cards associated with any external accounts maintained at any financial institution). Such a debit card operates to enable a user access to funds that may be transferred to a gaming device of a gaming establishment and/or used at one or more channels of commerce associated with the gaming establishment and/or independent of the gaming establishment. For example, as seen in FIG. 1, the gaming establishment fund management system that maintains the enterprise wallet 104 is in communication with an enterprise electronic wallet system 128 to access an amount of funds held in a checking account opened by the enterprise electronic wallet system on behalf of a user and employing a debit card (and/or other payment instrument) provided to the user. In this example, as also seen in FIG. 1, the network of one or more banks or other financial institutions (i.e., the banking network 122) is in communication with the enterprise electronic wallet system 128 to facilitate at least the settlement of funds held in the created accounts accessed via a debit card provided to the user. It should be appreciated that while illustrated as the gaming establishment fund management system being in communication with one or more enterprise electronic wallet systems to facilitate the transfer of funds, in different embodiments, any system or sub-system of the present disclosure can be in communication with one or more enterprise electronic wallet systems to facilitate the transfer of funds. It should be further appreciated that in different embodiments, the system utilizes a mobile device running a mobile device application, a kiosk, a gaming device (e.g., an interface of an EGM or gaming table component), a service window displayed by a gaming device (e.g., a remote host controlled service window displayed by an EGM), a component of a gaming establishment patron management system, such as a player tracking unit, and/or a gaming establishment interface to interface with the enterprise electronic wallet system.

In certain embodiments, the enterprise electronic wallet system is associated with a single gaming establishment. In certain embodiments, the enterprise electronic wallet system is associated with a plurality of gaming establishments. In certain embodiments, the dedicated bank account is associated with a single gaming establishment. In these embodiments, a separate dedicated bank account is created on behalf of each eligible user of each individual gaming establishment. In certain embodiments, the dedicated bank account is associated with a group of gaming establishments. In these embodiments, a dedicated bank account is created on behalf of each eligible user of the group of a gaming establishments.

In certain embodiments, the balance of one or more dedicated bank accounts created by and/or integrated with the enterprise electronic wallet system on behalf of a user are drawn down via transactions initiated by the provided payment instrument (e.g., debit card) and accessible at a point-of-sale-terminal external from any gaming establishment channel of commerce (e.g., a non-gaming establishment retailer 130 in communication, via the banking network 122). In these embodiments, the dedicated bank account linked to a gaming establishment account associated with the user, such as a cashless wagering account, facilitates the movement of funds external from a gaming establishment environment via a component of an external retail establishment interfacing with a component of the gaming establishment fund management system that maintains the gaming establishment account.

In certain embodiments, in association with the employment of a dedicated bank account associated with (or otherwise linked to) a gaming establishment account, the system provides the user a payment instrument, such as a debit card, an Automated Teller Machine (“ATM”) card, and/or one or more negotiable instruments (e.g., one or more checks, money orders and/or promissory notes), to facilitate the use of funds residing in the dedicated bank account. In one such embodiment, the payment instrument, such as a debit card, takes the form of a physical instrument (e.g., a smart debit card that stores account information, a magnetic striped debit card that stores account information, a smart debit card that does not store any account information but is associated with a debit card number that is associated with account information in one or more maintained databases, a magnetic striped debit card that does not store any account information but is associated with a debit card number that is associated with account information in one or more maintained databases). In another such embodiment, the payment instrument, such as a debit card, additionally or alternatively takes the form of a virtual instrument (e.g., a mobile device application that stores account information, a mobile device application that does not store any account information but is associated with a debit card number that is associated with account information in one or more maintained databases, and/or a component of a mobile device operating system that stores account information and is operable with a point-of-sale terminal). In one such embodiment, information associated with the virtual debit card is communicated from the financial institution to a gaming establishment mobile device application running on the user's mobile device. In another such embodiment, information associated with the virtual debit card is communicated from the financial institution to the user's mobile device to be stored in a wallet application being run on the user's mobile device.

In certain embodiments, to provide a user instant access outside of a gaming establishment to funds that would otherwise reside in a gaming establishment account for gaming purposes, the system of the present disclosure creates and/or integrates a bank account with a gaming establishment account maintained for that user. Such a configuration enables funds to be accessed both at gaming establishment verticals and non-gaming establishment verticals without the need to wait for any extended periods of time for fund transfers from a gaming establishment account to an external financial institution account to be completed (or alternatively pay various surcharge fees to expedite such fund transfers).

In certain embodiments, the system enables a user to transfer funds from a dedicated bank account associated with (or otherwise linked to) a gaming establishment account to/from an account associated with a retail system in association with one or more components of the gaming establishment fund management system, such as a component of a cashless wagering system. In these embodiments, the enterprise electronic wallet system (that created or otherwise integrated the dedicated bank account associated with a gaming establishment account) operates individually or collectively with one or more other components to facilitate the transfer of funds to one or more destinations. In certain embodiments, the user interfaces with one or more components associated with the gaming establishment fund management system to transfer an amount of funds to an account associated with a retail system (to settle a purchase transaction occurring at a point-of-sale terminal) and the enterprise electronic wallet system operates, individually or collectively, to potentially complete the transfer of funds from the dedicated bank account associated with the gaming establishment account. In certain such embodiments, responsive to the retail system requesting an amount of funds to complete a purchase transaction initiated with a payment instrument associated with the dedicated bank account, the gaming establishment fund management system initiates a requested transfer of funds from the dedicated bank account to complete the purchase transaction. In such embodiments, responsive to a request to complete a purchase of goods and/or services for an amount of funds, one or more components of a gaming establishment fund management system operate with one or more components that maintains the dedicated bank account associated with the gaming establishment account to potentially execute the transfer and complete the purchase. In these embodiments, subject to the transfer being approved, the one or more components of the gaming establishment fund management system transfer (or otherwise approve a transfer for subsequent settlement upon an occurrence of a settlement event) an amount of funds from the dedicated bank account.

In certain embodiments, the balance of one or more dedicated bank accounts created by or otherwise integrated with the enterprise electronic wallet system on behalf of a user are additionally or alternatively drawn down via transactions accessible at a point-of-sale terminal 116 within a gaming establishment channel of commerce. In these embodiments, the dedicated bank account linked to a gaming establishment account associated with the user, such as a cashless wagering account, facilitates the movement of funds within a gaming establishment environment via a component of a gaming establishment retail establishment interfacing with a component of the gaming establishment fund management system that maintains the gaming establishment account.

In certain embodiments, the balance of one or more dedicated bank accounts created by or otherwise integrated with the enterprise electronic wallet system on behalf of a user are additionally or alternatively drawn down via transactions accessible at a gaming device, such as an EGM 106 and/or a gaming table 108a. In these embodiments, the dedicated bank account linked to a gaming establishment account associated with the user, such as a cashless wagering account, facilitates the movement of funds within a gaming establishment environment via a gaming device interfacing with a component of the gaming establishment fund management system that maintains the gaming establishment account. For example, upon a user's request to transfer to an EGM of a gaming establishment an amount of funds displayed as being held in a cashless wagering account maintained for that user (but actually held in a dedicated bank account dedicated to that user), one or more components of the system operate to transfer the funds, without any external bank account transfer delays, from the dedicated bank account to the EGM. In this example, such a transfer occurs via an indirect transfer from the dedicated bank account to the cashless wagering account maintained for the user and then to the EGM (or via a direct transfer, facilitated by a cashless wagering system that maintains the cashless wagering account, from the dedicated bank account to the EGM). In another example, upon a user cashing out an amount of funds from an EGM of a gaming establishment (i.e., an occurrence of a funding event), one or more components of the system operate to transfer the funds to a dedicated bank account such that the funds become available for use within the gaming establishment as well as outside of the gaming establishment. In this example, such a transfer occurs via an indirect transfer from the EGM to a cashless wagering account maintained for that user and then to the dedicated bank account (or via a direct transfer, facilitated by a cashless wagering system that maintains the cashless wagering account, from the EGM to the dedicated bank account).

It should be appreciated that in addition to transferring, directly or indirectly, funds between a gaming establishment account and a dedicated bank account, since the gaming establishment account maintained for the user is associated with one or more backing bank accounts that hold at least a corresponding amount of funds as the funds attributed to the gaming establishment account, when funds move between the gaming establishment account and the dedicated bank account, the system creates one or more ledgers of the existence of a debt between the sender of the funds and the receiver of the funds. In these embodiments, upon an occurrence of a settlement event, such as after a designated period of time (e.g., at the end of a day), the system reconciles such outstanding debt by initiating the transfer of funds between the appropriate bank accounts.

It should be further appreciated that unlike prior payment solutions in which if a user wants to access their funds held in a casino account at a retail establishment outside of the casino, the user needs to first transfer their funds to an external bank account (after which the user can then pay at that retail establishment outside of the casino using a debit card or credit card associated with their external bank account), or alternatively first transfer their funds to an external electronic wallet (after which the user can use a pre-paid debit card associated with their external electronic wallet to pay at that retail establishment outside of the casino), the employment of the dedicated bank account (with the incorporation of certain additional benefits as part of the transaction and/or the issuance of certain additional benefits upon completion of the transaction) enables the user to avail themselves of the use of a payment instrument, such as a debit card, for purchases made outside of the casino while still having funds readily available for use within the casino.

Accordingly, in certain embodiments, the system of the present disclosure enables funds that previously were not immediately accessible outside of a casino to become accessible (with the incorporation of certain additional benefits as part of the transaction and/or the issuance of certain additional benefits upon completion of the transaction) via a payment instrument associated with a dedicated bank account (that is dedicated to the user, associated with the user's gaming establishment account and remains owned by the system of the present disclosure). In these embodiments, by associating a gaming establishment account maintained for a user, a bank account dedicated to the user and linked to the gaming establishment account and an electronic wallet (e.g., a financial transaction application that runs on a mobile device and securely stores payment information, such as debit card information, and passwords to enable the payment of goods and/or services), the system of the present disclosure operates to enable benefits to be procured while funds flow between different verticals quicker than previously available. In other words, by integrating a bank account created in association with the system directly with one or more gaming establishment accounts, the present disclosure enables a payment instrument associated with the dedicated bank account to function as an interface (and a benefit driving engine) to access funds independent of any involvement of any other external accounts that require a relatively extended period of time to transfer funds to. In addition to realizing certain benefits associated with a purchase transaction, such a configuration enables a user to access the network payment processors accessible with certain payment instruments, such as debit cards, without first needing to transfer any amounts of funds from a gaming establishment account to an external account associated with the debit card to gain such access. Such a configuration additionally saves users time (e.g., no time needs to be spent transferring funds from a gaming establishment account to an external banking account associated with a debit card or waiting a dedicated amount of time for such a transfer to be completed) and offers operational efficiencies (e.g., reducing the number of touchpoints funds must flow through before they may be used) compared to prior payment solutions involving funds in a casino account.

It should be appreciated that prior systems that did not offer any benefits, required one or more inputs to transfer funds in a gaming establishment account to an external financial institution account associated with a debit card and further required a certain amount of time, such as up to three days, for the transfer to be completed and the transferred funds to become available using a debit card. Unlike such prior systems, the system of present disclosure offers one or more benefits as part of the transaction and/or upon completion of the transaction, bypasses the prolonged transfer periods (and in doing so further bypasses the need for the external financial institution account previously employed) and enables the system to interact, in real time, with various non-gaming establishment components such that the funds that otherwise would have to be maintained in a gaming establishment account are available, via the employment of the dedicated bank account, for immediate use at a non-gaming device (via employing a payment instrument associated with such an account as a gateway to such funds). As such, in addition to realizing certain benefits associated with a purchase transaction, the system of the present disclosure offers the advantages of bank account transactions without the fund transfer friction and timing restrictions previously encountered in moving funds from a gaming establishment account, thereby providing the user greater control over their funds.

Accordingly, in view of the different channels of commerce available both in association with and independent of one or more gaming establishments, the system offers a dedicated bank account that enables access to funds in different channels of commerce associated with or independent of one or more gaming establishments. Such transfers thus reduce the fund movement friction encountered in using funds otherwise held in a gaming establishment account to complete transactions outside of the gaming establishment network while still realizing the benefits of network payment processors offered by the use of payment instruments associated with the dedicated bank account. Such a configuration further facilitates, amongst other benefits, a more cashless environment (e.g., cash does not need to be withdrawn from a gaming establishment account and then brought to a retailer, either internal to or external from the gaming establishment, to purchase goods and/or services) which increases safety (e.g., minimizing users having to carry large sums of cash associated with large sums of money and minimizing such cash being a vehicle to spread potentially harmful contagions).

In certain embodiments, the system enables the user to fund one or more maintained accounts (e.g., the dedicated bank account associated with a gaming establishment account) using one or more bank account transfers (e.g., an automated clearing house (“ACH”) transfer), a guaranteed ACH transfer, and/or an electronic check (“eCheck”) transfer). In certain embodiments, the system enables the user to fund one or more maintained accounts (e.g., the dedicated bank account associated with a gaming establishment account) using one or more of a transfer based on credit card information, a transfer based on external debit card information, a transfer based on a third-party maintained account (e.g., one or more PayPal® accounts or Venmo® accounts). In certain embodiments, the system enables the user to fund one or more maintained accounts (e.g., the dedicated bank account associated with a gaming establishment account) using a mobile device electronic fund transfer, such as using Apple Pay™ or Android Pay™. It should be appreciated that in different embodiments, the system utilizes a mobile device running a mobile device application, a kiosk, an EGM, a gaming table component, a service window displayed by a gaming device (e.g., a remote host controlled service window displayed by an EGM) and/or a gaming establishment interface to facilitate the transfer of funds from a third-party account to the maintained account.

In certain embodiments, the system enables funds to be deposited in one or more maintained accounts (e.g., the dedicated bank account associated with a gaming establishment account) via activating a line of credit associated with the user. In certain embodiments, the system enables funds to be deposited in one or more maintained accounts (e.g., the dedicated bank account associated with a gaming establishment account), via a gaming device, such as an EGM and/or via a non-gaming device, such as a kiosk. In certain embodiments, the system enables a user that has an amount of cash to utilize a gaming device and/or a non-gaming device to convert the cash to an amount deposited into one or more maintained accounts (e.g., the dedicated bank account associated with a gaming establishment account). In certain embodiments, the system enables funds to be deposited in one or more maintained accounts (e.g., the dedicated bank account associated with a gaming establishment account) via a gaming establishment interface, such as a gaming establishment cage or desk. In certain embodiments, the system enables a user that has an amount of cash to utilize a gaming establishment interface, such as a gaming establishment cage or desk to convert the cash to an amount deposited into one or more maintained accounts (e.g., the dedicated bank account associated with a gaming establishment account).

In certain embodiments, the system enables funds to be deposited in one or more maintained accounts (e.g., the dedicated bank account associated with a gaming establishment account) via a gaming device and/or a non-gaming device that accepts printed ticket vouchers. In these embodiments, the system enables a user that has one or more printed ticket vouchers to utilize a gaming device and/or a non-gaming device to convert the printed ticket voucher to an amount deposited into one or more maintained accounts (e.g., the dedicated bank account associated with a gaming establishment account). In other embodiments, the system enables funds to be deposited in one or more maintained accounts (e.g., the dedicated bank account associated with a gaming establishment account) via a gaming establishment interface that accepts printed ticket vouchers. In these embodiments, the system enables a user that has one or more printed ticket vouchers to utilize a gaming establishment interface to convert the printed ticket voucher to an amount deposited into one or more maintained accounts (e.g., the dedicated bank account associated with a gaming establishment account). In certain embodiments, one or more maintained accounts (e.g., the dedicated bank account associated with a gaming establishment account) are associated with funds associated with one or more virtual ticket vouchers. In certain embodiments, the system enables a user associated with an amount of virtual ticket vouchers to utilize a gaming device (e.g., an EGM, or a component of an EGM), a non-gaming device (e.g., a kiosk), a mobile device running a mobile device application, and/or a gaming establishment interface to convert the virtual ticket vouchers to an amount deposited into one or more maintained accounts (e.g., the dedicated bank account associated with a gaming establishment account).

It should be appreciated that the electronic fund data transfers of the present disclosure may occur in addition to or as an alternative from cash-based fund transfers and/or ticket voucher-based fund transfers. In one such embodiment, an amount of funds transacted against is funded via any of an electronic fund transfer, a cash-based fund transfer or a ticket voucher-based fund transfer. In another embodiment, an amount of funds transacted against is funded via an electronic fund transfer or a cash-based fund transfer (but is not funded via any ticket voucher-based fund transfer). In another embodiment, an amount of funds transacted against is funded via an electronic fund transfer or a ticket voucher-based fund transfer (but is not funded via any cash-based fund transfer). In another embodiment, an amount of funds transacted against is funded via an electronic fund transfer (but is not funded via a cash-based fund transfer nor a ticket voucher-based fund transfer).

In certain embodiments, the gaming establishment fund management system is in communication with one or more gaming establishment patron management systems (e.g., player tracking system 132 of FIG. 1) that monitor activities at various points of contact associated with the gaming establishment and/or external from the gaming establishment. In certain embodiments, the monitored activity enables the gaming establishment patron management system to provide benefits, such as redeemable player tracking points, in association with such activities. In certain embodiments, as described in more detail below, the monitoring of activity includes the receipt of certain retail purchase information (e.g., retail ratings) that enables the gaming establishment patron management system to determine and provide one or more benefits in association with a retail purchase transaction employing the dedicated bank account associated with a gaming establishment account. It should be appreciated that while, in certain embodiments, the gaming establishment fund management system is in communication with one or more gaming establishment patron management systems, in different embodiments, any system or sub-system of the present disclosure can be in communication with one or more gaming establishment patron management systems. For example, while information associated with one or more retail transactions are shown in FIG. 1 as being communicated directedly from the enterprise electronic wallet system to the player tracking system, such information may be communicated indirectly via one or more intermediaries, such as enterprise wallet. In different embodiments, the system utilizes a mobile device running a mobile device application, a kiosk, an interface of a gaming device (e.g., an interface of an EGM or gaming table component), a service window displayed by a gaming device (e.g., a remote host controlled service window displayed by an EGM), a component of a gaming establishment patron management system, such as a player tracking unit, and/or a gaming establishment interface to interface with the gaming establishment patron management system.

In certain embodiments, the gaming establishment fund management system is in communication with one or more credit systems which each issue the user one or more lines of credit. These lines of credit are accessible to facilitate a transfer of funds from the line of credit issued by the credit system to (either directly or indirectly through a cashless wagering account) a credit balance of a gaming device, such as an EGM and/or a gaming table and/or to (either directly or indirectly through a gaming establishment retail account) a point-of-sale terminal (or an account associated with the point-of-sale terminal). It should be appreciated that the gaming establishment fund management system may be in communication with one or more credit systems, and in different embodiments, any system or sub-system of the present disclosure can be in communication with one or more credit systems. It should be further appreciated that in different embodiments, the system utilizes a mobile device running a mobile device application, a kiosk, a gaming device (e.g., an interface of an EGM or gaming table component), a service window displayed by a gaming device (e.g., a remote host controlled service window displayed by an EGM), a component of a gaming establishment patron management system, such as a player tracking unit, and/or a gaming establishment interface to interface with the gaming establishment credit system.

In certain embodiments, the gaming establishment fund management system is also in communication with one or more credit reporting/credit risk systems which monitor and report on various accounts associated with the user. For example, the gaming establishment fund management system that maintains the enterprise wallet is in communication with one or more credit reporting and risk systems. These credit reporting and risk systems monitor and report on a credit rating and status of one or more accounts maintained for the user at various funding sources, such as various financial institutions. It should be appreciated that while, in certain embodiments, the gaming establishment fund management system being in communication with one or more credit reporting networks and one or more credit reporting/credit risk systems, in different embodiments, any system or sub-system of the present disclosure can be in communication with one or more credit reporting/credit risk systems.

In certain embodiments, the system utilizes one mobile device application to interact with the different components of the gaming establishment fund management system to, amongst other actions, access funds maintained in the different gaming establishment accounts associated with the user. For example, utilizing the same mobile application, a mobile device interacts with both the first cashless wagering system of the gaming establishment fund management system and the gaming establishment retail wallet system of the gaming establishment fund management system. In certain embodiments, the system utilizes multiple mobile device applications to interact with the different components of the gaming establishment fund management system to, amongst other actions, access funds maintained in the different gaming establishment accounts associated with the user. In certain of these embodiments, the mobile device applications include a location based digital wallet enabled application, such as a Passbook-enabled or Wallet-enabled application, which is accessible when the user enters a gaming establishment. In certain of such embodiments, the mobile device applications are downloaded to the mobile device from an application store. In certain of such embodiments, the mobile device applications are downloaded to the mobile device from one or more websites affiliated with the gaming establishment (which are accessible directly by the user and/or by a link opened when the user scans a QR code).

It should be appreciated that in different embodiments, in addition to or alternatively from utilizing a mobile device running a mobile device application to, amongst other actions, access funds associated with different gaming establishment accounts, the system utilizes a kiosk, a gaming device (e.g., an interface of an EGM or gaming table component), a service window displayed by a gaming establishment device (e.g., a remote host controlled service window displayed by an EGM), a display device/input device associated with a seat-level gaming table component, a display device/input device associated with a table-level gaming table component, a display device/input device associated with a mobile gaming table component, a component of a gaming establishment patron management system, such as a player tracking unit, a retail point-of-sale terminal, and/or a gaming establishment interface, such as a casino desk, to, amongst other actions, access the funds associated with such gaming establishment accounts. It should be further appreciated that while illustrated in FIG. 1 as using a mobile device running a mobile device application to access funds associated with different gaming establishment accounts (e.g., a cashless wagering account and a gaming establishment retail account) as mentioned above, a physical instrument, such as a smart card or a user issued magnetic striped card may additionally or alternatively be utilized to enable a user access to such gaming establishment account.

In certain embodiments, the system enables a transfer of funds between different accounts maintained by different components associated with different gaming activities and/or non-gaming activities. In these embodiments, the system employs one or more services for interfacing with the various components to facilitate balance inquiry and transferring funds amongst the different accounts maintained by these various components. In certain embodiments, such a service collects data from various components and utilizes such collected data to provide a singular view of the balances (or a plurality of singular views of different groupings of balances). In certain embodiments, such a service additionally or alternatively provides facilities to enforce rules associated with the different accounts maintained by the various components. In different such embodiments, these rules include, but are not limited to, jurisdictional controls, self-imposed limits, state governmental controls and federal governmental controls, wherein the system provides the logic to determine how, and how much, to transfer from each account of the various interconnected components to satisfy a request for funds while staying within the confines of such rules. In certain embodiments, such a service additionally or alternatively tracks and coalesces transaction history across the accounts of the interconnected components of the system. In these embodiments, all transactions within the system have a “master” transaction record that ties all of the various fund transfers to a single initiating funds transfer regardless of how many accounts were withdrawn to the satisfy the original request.

In certain embodiments, as mentioned above, the system enables a user to attempt to make certain retail transactions using the payment instrument associated with the bank account. In certain embodiments, to employ a payment instrument associated with the dedicated bank account to facilitate the use of funds from that account to an account associated with a retailer to purchase goods and/or services from the retailer, the user presents the payment instrument, such as a debit card, to potentially access the funds in the dedicated bank account for the purchase transaction. In certain such embodiments, the debit card takes the form of a physical instrument presented to a point-of-sale terminal. In certain other embodiments in which the payment instrument is presented in virtual or electronic form using a mobile device application, such as an electronic wallet that stores debit card data, the mobile device application prompts the user to cause the mobile device to engage the point-of-sale terminal, such as prompting the user to tap the mobile device to a designated portion of the point-of-sale terminal (or otherwise moving the mobile device to within a designated distance of a designated location of the point-of-sale terminal). Such engagement initiates a pairing or linkage between the mobile device and the point-of-sale terminal, wherein the pairing or linkage between the mobile device and the point-of-sale terminal occurs via one or more applications being run or executed on the mobile device. In this example, after such engagement, the mobile device application communicates, via a wireless communication protocol (including, but not limited to: Bluetooth™, Bluetooth™ Low Energy (“BLE”), one or more cellular communication standards (e.g., 3G, 4G, 5G, 6G, LTE), one or more Wi-Fi compatible standards, and one or more short range communication protocols (e.g., a near field communication (“NFC”) protocol), data associated with the debit card to the point-of-sale terminal to facilitate the potential purchase of goods and/or services.

It should be appreciated that in certain embodiments, the user needs to take one or more steps to approve a transaction to access funds in a dedicated bank account using a payment instrument, such as a debit card. In one such embodiment, the user acknowledges the approval of accessing funds in the bank account associated with the gaming establishment account using the payment instrument, when needed, by entering PIN via a mobile device application, providing a signature and/or presenting a biometric identifier to a mobile device. In another embodiment, the user acknowledges the approval of accessing funds in the bank account associated with the gaming establishment account using a payment instrument, when needed, by entering a PIN, providing a signature and/or presenting a biometric identifier to the retail point-of-sale terminal or a peripheral device associated with the retail point-of-sale terminal.

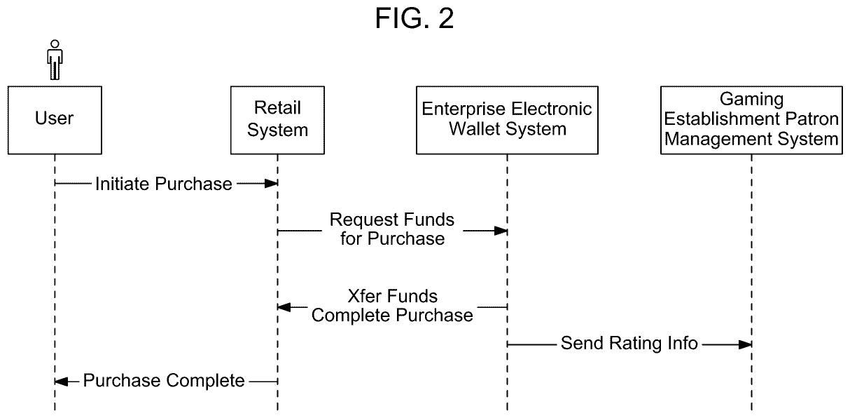

In certain embodiments in which the system provides certain benefits following a completion of the retail transaction, upon the presentation of the payment instrument at an applicable point-of-sale terminal of a retail point-of-sale system to initiate a purchase transaction, the components of the systems individually or collectively determine whether or not to complete the attempted retail purchase using funds maintained in the dedicated bank account associated with (or otherwise linked to) the gaming establishment account. In these embodiments, subject to the dedicated bank account associated with the gaming establishment account having adequate funds for the purchase transaction, the system authorizes (or alternatively denies for lack of adequate funds) the purchase transaction, transfers the applicable amount of funds to an account associated with the retail point-of-sale system and communicates certain data associated with the purchase transaction to a component tasked with offering one or more benefits based on the completed purchase transaction using funds from the dedicated bank account. For example, as seen in FIG. 2 (which illustrates the described interactions between the user, the retail point-of-sale system, the enterprise electronic wallet system associated with the dedicated bank account, and a gaming establishment patron management system), following the user presenting a payment instrument to a retail point-of-sale system to initiate a purchase, the retail point-of-sale system communicates a request for an amount of funds needed to complete the purchase to the enterprise electronic wallet system associated with the dedicated bank account. In this example (not shown), if the enterprise electronic wallet system associated with the dedicated bank account determines that the dedicated bank account lacks adequate funds to compete the purchase, the enterprise electronic wallet system notifies the retail point-of-sale system to deny the purchase and does not cause any funds to be transferred in association with the denied purchase transaction. On the other hand, if the enterprise electronic wallet system determines that the dedicated bank account has adequate funds to compete the purchase, the enterprise electronic wallet system notifies the retail point-of-sale system to complete the purchase.

More specifically, upon the presentation of the payment instrument at an applicable point-of-sale terminal of a retail point-of-sale system, the components of the systems individually or collectively determine whether or not to complete the attempted retail purchase using funds maintained in the dedicated bank account. In these embodiments, upon receiving data or information regarding the payment instrument, the retail point-of-sale system communicates with the enterprise electronic wallet system to request a transfer of an amount of funds to cover the cost of the intended purchase. The enterprise electronic wallet system operates with zero, one or more other components to determine if the dedicated bank account has adequate funds for the intended purchase. That is, upon the requested transfer of funds to complete the retail purchase using funds in a dedicated bank account, one or more components of the present disclosure operate to log a user into one or more accounts (if necessary) and determine whether to authorize the transfer of the determined amount of funds.

If the enterprise electronic wallet system indicates that the dedicated bank account lacks adequate funds for the purchase, the enterprise electronic wallet system denies this sale transaction of the goods and/or services using the dedicated bank account. One or more denial messages of the sale transaction of the goods and/or services using the account are communicated to the retail point-of-sale system. On the other hand, if the enterprise electronic wallet system confirms the presence of adequate funds in the dedicated bank account, the enterprise electronic wallet system authorizes the sale of the goods and/or services. The enterprise electronic wallet system then proceeds to modify a balance of the dedicated bank account to reflect a debit to cover the purchased goods and/or services. In addition to accounting for the purchase price of the goods and/or services by reducing a balance of the dedicated bank account, the enterprise electronic wallet system communicates one or more authorization messages of the sale transaction of the goods and/or services to the retail point-of-sale system to complete the sale of the goods and/or services. Such a completed purchase of the goods and/or services is associated with a transaction identification which one or more components of the system store for reporting purposes.

It should be appreciated that while the use of a payment instrument associated with a dedicated bank account to access funds includes the modification of the balance of the dedicated bank account based on such access, the settlement of such funds with the retailer occurs upon a settlement event. In these embodiments, the amount to cover the purchased goods and/or services with funds in the dedicated bank account are subsequently transferred, as part of a settlement process, from a backing bank account to a retailer bank account associated with the retailer. Such a settlement event occurs automatically at a preset interval or point in time, automatically in real time, and/or responsive to one or more inputs received to initiate the settlement event. In these embodiments, upon an occurrence of the settlement event, a financial institution associated with the enterprise electronic wallet system operates with a financial institution associated with the retailer to cause a transfer of an amount of funds between the dedicated bank account and the financial institution account associated with the retailer. In certain such embodiments, since one or more jurisdictions require that the amount of funds associated with one or more gaming establishment accounts maintained by a gaming establishment fund management system for one or more users are secured by a corresponding amount of funds in one or more backing bank accounts for the gaming establishment and since the dedicated bank account is effectively operating as the gaming establishment account for certain transactions occurring within a gaming establishment, to account for the use of funds flowing to and/or from such a dedicated bank account, the system causes, either in association with each transaction or in association with a plurality of transactions, the transfer of funds between the different backing bank accounts associated with the gaming establishment and the retailer where the payment instrument was used. Such settlement transfers not only ensure that the retailer is paid for the goods and/or services purchased using the payment instrument associated with the dedicated bank account (or alternative the user is credited for the refund transaction associated with the payment instrument), but such settlement transfers further ensure that the amounts maintained in the dedicated bank account comply with jurisdictional requirements by corresponding with the amounts maintained in the one or more associated backing bank accounts.

In certain embodiments, in addition to potentially approving the transfer of funds from the dedicated bank account to complete the purchase, the system utilizes certain information associated with the purchase to potentially determine one or more benefits associated with the purchase (which are independent of the goods and/or services purchased). For example, as further seen in FIG. 2, following the completion of the purchase, the enterprise electronic wallet system sends certain information associated with the purchase (e.g., rating information) to a gaming establishment patron management system. In this example, the gaming establishment patron management system, such as a player tracking system, utilizes this information to determine one or more aspects of one or more benefits for the user in association with the completed purchase transaction. Put differently, following the receipt of certain information associated with the purchase transaction (e.g., the rating information), the gaming establishment patron management system determines whether to associate any benefits (e.g., any monetary benefits and/or any discounts on subsequent purchases) based on the completed purchase transaction.

Accordingly, in certain embodiments, the system of the present disclosure receives a retail rating of an authorized purchase transaction that occurred at a point-of-sale terminal in association with an amount of funds maintained in a dedicated bank account associated with a first gaming establishment account. In these embodiments, the system determines, based on the received retail rating, a benefit, and associates the determined benefit with a second gaming establishment account.

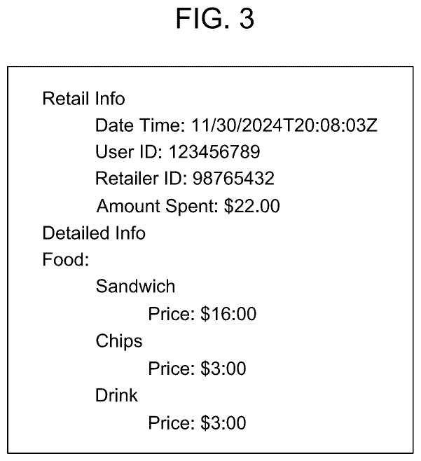

In certain embodiment, the information associated with the purchase transaction (e.g., the rating information) includes any suitable information to aid one or more components, such as the component of the gaming establishment patron management system, in analyzing the purchase and determining one or more attributes of a benefit, such as a discount on one or more future purchases. In different embodiments, certain of which are seen in FIG. 3, the information communicated to the gaming establishment patron management system includes, but is not limited to, user identification data (e.g., account number, userID), date and time of the purchase transaction, amounts spent in association with the purchase transaction, goods and/or services associated with the purchase transaction, location of the purchase transaction, retail establishment associated with the purchase transaction, and/or a Merchant Category Code (MCC) associated with the retail establishment.

In certain embodiments, the determination to provide any benefits in association with the retail transaction and/or the attributes of any such benefits is additionally or alternatively based on one or more parameters of the retail establishment. For example, as part of a marketing campaign associated with the retail establishment, the system associates one or more benefits with one or more users. In this example, which users qualify for benefits is based on the user's historical retail purchasing activity at that retail establishment. In certain such embodiments, a determination to provide any benefits in association with the retail transaction and/or a determination of the attributes of any such benefits occurs responsive to one or more inputs received from personnel associated with the retailer.

In certain embodiments, the determination to provide any benefits in association with the retail transaction and/or the attributes of any such benefits is additionally or alternatively based on an identity of the user. In one such embodiment, different users having different status with the gaming establishment are offered different benefits. In another such embodiment, the system determines to provide any benefits in association with the retail transaction and/or the attributes of any such benefits based on determined historical preferences of the user.

In certain embodiments, the determination to provide any benefits in association with the retail transaction and/or the attributes of any such benefits is additionally or alternatively based on one or more actions of a user. In certain such embodiments, in exchange for signing up to participate in a player loyalty program (i.e., opening a player tracking account), the system determines to associate one or more benefits for completing the retail transaction employing the dedicated bank account. In another such embodiment, in exchange for signing up to participate in a gaming establishment fund management system program (i.e., opening a gaming establishment fund management account or linking a player tracking account to a gaming establishment fund management account), the system additionally or alternatively determines to associate one or more benefits for completing the retail transaction employing the dedicated bank account. In another such embodiment, in exchange for linking a gaming establishment fund management account with a debit card, the system additionally or alternatively determines to associate one or more benefits for completing the retail transaction employing the dedicated bank account.

In another embodiment, the system additionally or alternatively determines to provide any benefits in association with the retail transaction and/or the attributes of any such benefits based on the user's retail purchasing activity. In another such embodiment, the system additionally or alternatively determines to provide any benefits in association with the retail transaction and/or the attributes of any such benefits based on the user's retail purchasing activity occurring independent of the gaming establishment. In another embodiment, the system additionally or alternatively determines to provide any benefits in association with the retail transaction and/or the attributes of any such benefits based on the user's wagering activity. In certain embodiments, the system additionally or alternatively determines to provide any benefits in association with the retail transaction and/or the attributes of any such benefits based on the user's collective experience at a gaming establishment, such as if the user wagers $100 on EGMs throughout a casino and spends $100 at a gaming establishment restaurant, the system determines a discount of $25 usable at a partner non-gaming establishment restaurant to associate.

In certain embodiments, the determination to provide any benefits in association with the retail transaction and/or the attributes of any such benefits is additionally or alternatively based on one or more parameters of the gaming establishment. For example, as part of a marketing campaign associated with the gaming establishment, the system associates one or more benefits with one or more users for completing the retail transaction employing the dedicated bank account. In certain embodiments, a determination to provide any benefits in association with the retail transaction and/or a determination of the attributes of any such benefits occurs responsive to one or more inputs received from gaming establishment personnel. In other embodiments, when the benefit is determined, the amount of funds currently maintained in the various gaming establishment fund management accounts associated with various users and the current rate of return the gaming establishment is realizing on the amount of funds in the various gaming establishment fund management accounts associated with various users factor into associating one or more benefits.

Accordingly, in certain embodiments, following a purchase transaction completed against a dedicated bank account associated with a first gaming establishment account, the system determines whether to associate any discounts with the purchase transaction completed against the dedicated bank account. In these embodiments, responsive to the determination being to associate a discount with the purchase transaction completed against the dedicated bank account, the system communicates data associated with an amount of funds determined based on the associated discount and the purchase transaction.

In certain embodiments, following the determination to provide a benefit in association with the retail transaction and/or the determination of the attributes of any such benefits, the system causes such benefits to be made available to the user. In certain embodiments, if the system determines to provide one or more benefits, the system stores benefit information in one or more accounts associated with the user. In one such embodiment, the system maintains a separate benefit account that stores data associated with the different benefits associated with the user. In another such embodiment, the system utilizes one or more gaming establishment accounts, such as a gaming establishment fund management account (e.g., a cashless wagering account or a gaming establishment retail account) or a player tracking account to store data associated with different benefits, such as obtained discounts, associated with the user. In certain additional or alternative embodiments, if the system determines to associate one or more benefits with the user, the system causes a physical media, such as a coupon, to be issued to the user (wherein to redeem, the user provides the physical media to retail personnel and/or scans a machine-readable code printed on the physical media).

In certain embodiments, the benefit determined following a completion of the purchase transaction employing the dedicated bank account includes a deposit of an amount of funds to one or more accounts of the user. In these embodiments, the gaming establishment patron management system notifies the gaming establishment fund management system to deposit an amount of monetary currency in an account associated with the user, such as depositing an amount of funds in a cashless wagering account associated with the user. In certain such embodiments, the amount of the benefit is based on the purchase transaction (i.e., the system retroactively applies a discount to the purchased goods and/or services by crediting a user's account with an amount discounted from the amount of the completed purchase). In these embodiments, the user would not directly receive a discount at the point of purchase, rather, the user would receive funds in a gaming establishment account, such as a cashless wagering account, equal to, or by some calculation, based on the original amount spent at the point of purchase.

In certain embodiments, the benefit determined following a completion of the purchase transaction employing the dedicated bank account includes the gaming establishment patron management system depositing an amount of non-monetary currency in an account associated with the user, such as depositing an amount of player tracking points and/or promotional credits in a player tracking account associated with the user. In certain embodiments, the benefit determined following a completion of the purchase transaction employing the dedicated bank account includes one or more discounts, coupons or promotions usable within and/or outside of the gaming establishment in association with a subsequent purchase transaction. In different embodiments, the benefit determined following a completion of the purchase transaction employing the dedicated bank account includes, but is not limited to, one or more of: a quantity of monetary credits, a quantity of non-monetary credits, a quantity of promotional credits, a quantity of player tracking points, a progressive award, a modifier, such as a multiplier, a quantity of free plays of one or more games, a quantity of plays of one or more secondary or bonus games, a multiplier of a quantity of free plays of a game, one or more lottery based awards, such as lottery or drawing tickets, a wager match for one or more plays of one or more games, an increase in the average expected payback percentage for one or more plays of one or more games, one or more comps, such as a free dinner, a free night's stay at a hotel, a high value product such as a free car, or a low value product, one or more bonus credits usable for online play, a lump sum of player tracking points or credits, a multiplier for player tracking points or credits, an increase in a membership or player tracking level, virtual goods associated with the system, virtual goods not associated with the system, an access code usable to unlock content on an internet. In certain such embodiment in which the benefit includes a play of a game to potentially win one or more awards, the play of the game includes, but is not limited to, a play of any suitable spinning reels game, a play of any suitable wheel game; a play of any suitable card game such as blackjack, poker or baccarat; a play of any suitable keno game; a play of any suitable bingo game; a play of any suitable offer and acceptance game; a play of any suitable award ladder game; a play of any suitable puzzle-type game; a play of any suitable persistence game; a play of any suitable selection game; a play of any suitable cascading symbols game; a play of any suitable ways to win game; a play of any suitable scatter pay game; a play of any suitable coin-pusher game; a play of any suitable elimination game; a play of any suitable stacked wilds game; a play of any suitable trail game; a play of any suitable bingo game; a play of any suitable video scratch-off game; a play of any suitable pick-until-complete game; a play of any suitable shooting simulation game; a play of any suitable racing game; a play of any suitable promotional game; a play of any suitable high-low game; a play of any suitable lottery game; a play of any suitable number selection game; a play of any suitable dice game; a play of any suitable skill game; a play of any suitable partial skill game; a play of any suitable auction game; a play of any suitable reverse-auction game; and/or a play of any suitable group game.

In certain embodiments, a benefit, such as a discount off a future retail purchase, is associated with a specific retail establishment. In certain embodiments, a benefit, such as a discount, is associated with a plurality of retail establishments. In certain embodiments, the plurality of retail establishments are associated with each other (e.g., sister stores at different locations or different stores located in the same mall) or independent of each other (e.g., distinct stores located remote from each other). In certain embodiments, a benefit, such as a discount, is associated with one or more participating retail establishments within a geographic location.

In certain embodiments, rather than determining one or more benefits post-purchase transaction (and making such benefits subsequently available), the system employs one or more benefits in the form of discounts as part of the purchase transaction. In these embodiments, one or more components operate individually or collectively to determine whether or not to apply one or more discounts to the purchase transaction as well as whether or not to complete the purchase transaction (with or without the application of any applicable discounts) using funds maintained in the dedicated bank account associated with the gaming establishment account.

In certain embodiments, upon the presentation of the payment instrument at an applicable point-of-sale terminal of a retail point-of-sale system to initiate a purchase transaction, one or more components of the system determine whether any discounts (i.e., benefits) are available for the requested purchase transaction. In these embodiments, prior to requesting any funds from the dedicated bank account to potentially complete the purchase transaction, the system first determines if any discounts are available and if so, which discounts to apply to the purchase transaction to modify one or more attributes of the purchase transaction.

In certain embodiments, the discounts are specific to the user such that the enterprise electronic wallet system operates with the gaming establishment patron management system to determine if any discounts are available for the user attempting to purchase the goods and/or services associated with the purchase transaction. In these embodiments, at the time of purchase, the enterprise electronic wallet system communicates certain data to the gaming establishment patron management system, such as a user identification, a purchase location, a date and time, and an amount of the purchase, to inquire if there are discounts available for the identified user. In certain such embodiments, if the gaming establishment patron management system responds that no discounts are available, the enterprise electronic wallet system proceeds, as described above, with potentially completing the purchase transaction based on the amount of funds in the dedicated financial institution account. If the gaming establishment patron management system responds that one discount is available, the enterprise electronic wallet system automatically applies that discount. If the gaming establishment patron management system responds that multiple discounts are available, in certain embodiments, the gaming establishment patron management system (and/or the enterprise electronic wallet system) enable the user to select which discount to apply. In certain other embodiments, if the gaming establishment patron management system responds that multiple discounts are available, the gaming establishment patron management system (and/or the enterprise electronic wallet system) determines which discount to apply. In these embodiments, this determination is based on one or more factors, such as, but not limited to, user identity, date and time of purchase, location of the purchase, amount of the purchase, any limitations associated with any discounts, and/or other discounts available.

Accordingly, in certain embodiments, following a purchase transaction requested against a dedicated bank account associated with a gaming establishment account, the system determines whether to apply any discounts in association with the purchase transaction. In these embodiments, responsive to a plurality of discounts being available and the determination being to apply a first discount of the plurality of discounts in association with the purchase transaction, the system communicates, to a component of a retail system, data associated with the applied first discount, and causes a first determination of whether to complete the purchase transaction to occur, the first determination being based, at least in part, on an amount of funds associated with the purchase transaction reduced by the applied first discount and an amount of funds associated with the dedicated bank account. Additionally, responsive to the plurality of discounts being available and the determination being to apply a second, different discount of the plurality of discounts in association with the purchase transaction, the system communicates, to the component of the retail system, data associated with the applied second, different discount, and causes a second determination of whether to complete the purchase transaction to occur, the second determination being based, at least in part, on the amount of funds associated with the purchase transaction reduced by the applied second, different discount and the amount of funds associated with the dedicated bank account.

In certain embodiments, the enterprise electronic wallet system associated with the dedicated financial institution account is preconfigured with discounts to apply, which may reduce the amount charged, when a purchase is made at a qualifying partner retailer with a payment instrument associated with the dedicated bank account. In certain such embodiments, the available discounts may change from time to time in which such changes include, but are not limited to, changes to the retailer where such discounts are applicable, changes to the amount of the discount applicable, changes to the date and time when the discount is applicable and/or changes to the users whom may participate in the discount.

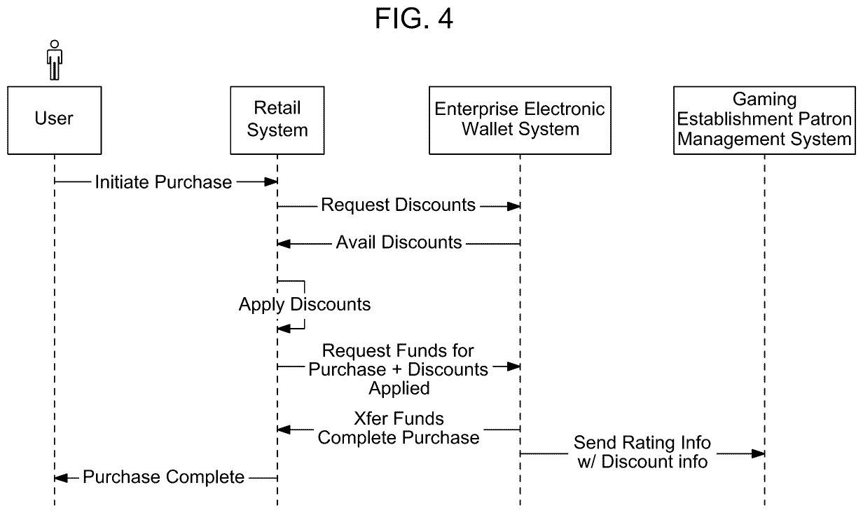

In certain embodiments, if a determination occurs to apply one or more discounts, the component of the gaming establishment system tasked with maintaining such discounts notifies, directly or indirectly the component of the retail establishment to apply the discount to the purchase transaction. Following any application of an available discount (or if a determination occurs not to apply any discounts), the enterprise electronic wallet system associated with the dedicated financial institution account determines whether or not to complete the purchase. In such embodiments, if the enterprise electronic wallet system denies the purchase (with or without the application of any discounts), the enterprise electronic wallet system notifies the point-of-sale terminal to deny the attempted purchase transaction without the application of any discounts. On the other hand, if the enterprise electronic wallet system approves the purchase (with or without the application of any discounts), the enterprise electronic wallet system transfers (or schedules a transfer of) the appropriate amount of funds (accounting for any applied discounts) to an account associated with the retail system and notifies the point-of-sale terminal to complete the attempted purchase transaction. For example, as seen in FIG. 4 (which illustrates the described interactions between the user, the retail point-of-sale system, the enterprise electronic wallet system associated with the dedicated bank account, and a gaming establishment patron management system), following the user presenting a payment instrument to a retail point-of-sale system to initiate a purchase, the enterprise electronic wallet system determines if any discounts are available in association with the purchase. If so, the enterprise electronic wallet system notifies the retail point-of-sale terminal of such discounts which are applied to reduce the purchase price of the goods and/or services. In this example, following the application of any applicable discount, the retail point-of-sale system requests an amount of funds needed to complete the purchase. If the enterprise electronic wallet system determines that the dedicated bank account lacks adequate funds (with or without the application of any discounts) to compete the purchase, the enterprise electronic wallet system notifies the retail point-of-sale system to deny the purchase. On the other hand, if the enterprise electronic wallet system determines that the dedicated bank account has adequate funds (with or without the application of any discounts) to compete the purchase, the enterprise electronic wallet system notifies the retail point-of-sale system to complete the purchase. Such a configuration enables discounting to be offered, in real time, for purchases made using a payment instrument of a financial institution account associated with a gaming establishment account. Such a configuration further enables funds to be accessed using a payment instrument issued by a financial institution without requiring a user to first make one or more inputs to transfer any funds from a gaming establishment account to any separate account and further without the need to wait for any fund transfer to be completed (or alternatively pay various surcharge fees to expedite any fund transfers).

Accordingly, in certain embodiments, following a purchase transaction requested against a dedicated bank account associated with a gaming establishment account, the system of the present disclosure determines whether to apply any discounts in association with the purchase transaction. In these embodiments, responsive to the determination being to apply a discount in association with the purchase transaction, the system communicates, to a component of a retail system, data associated with the applied discount, and causes a first determination of whether to complete the purchase transaction to occur, the first determination being based, at least in part, on an amount of funds associated with the purchase transaction reduced by the applied discount and an amount of funds associated with the dedicated bank account. Put differently, in certain embodiments, responsive to a receipt of data associated with a purchase transaction associated with a first amount of funds that is initiated at a point-of-sale terminal in association with a dedicated bank account associated with a gaming establishment account, the system automatically applies a discount to the purchase transaction, and enables the purchase transaction to be completed for a second amount of funds that is less than the first amount of funds. In these embodiments, responsive to a receipt of data associated with a purchase transaction associated with the first amount of funds that is initiated at the point-of-sale terminal independent of any dedicated bank account associated with any gaming establishment account, the system enables the purchase transaction to be completed for the first amount of funds.

In certain embodiments, prior to utilizing a benefit, such as a discount, being redeemed, the system determines if any qualifying criteria associated with that benefit are satisfied. In certain such embodiments, the qualifying criteria pertain to when that benefit may be redeemed. In certain such embodiments, the qualifying criteria additionally or alternatively pertain to the user completing one or more activities, such as the user having to make a minimum purchase amount for a benefit, such as a discount, to become redeemable.

In certain embodiments, a benefit, such as a discount, is associated with one or more limits or control. In these embodiments, prior to a benefit, such as a discount, being redeemed, one or more components of the present disclosure determine whether any applicable limits or controls are in place that prevent the benefit from being redeemed. Such limits or controls offer protection to the party funding the benefit by ensuring that benefit use corresponds with the intention of the promotional program.

In certain embodiments, the benefit limits are associated with an identity of whom may initiate a transaction. For example, a component of the gaming establishment patron management system determines that a user enrolled in player tracking system who qualifies as a bronze status member may have access to a first tier of discounts, while another user who qualifies as a platinum status member may have access to a second tier of discounts. In certain embodiments, one or more activities of the identified user may factor into the employment (or lack thereof) of the benefit limits. For example, the gaming establishment fund management system adjusts the benefit limit amount based on one or more of, has the user wagered or started a gaming session recently (e.g., last day, last hour), has the user won at a gaming establishment (and if so, the amount of those winnings), and/or is the user checked into the hotel of the gaming establishment.

In certain embodiments, the benefit limits are associated with a quantity and/or an amount of transactions that attempt to apply the benefit over a given period of time (e.g., hourly, daily, weekly, monthly). In these embodiments, to prevent a user from employing too many benefits, the system places a per time period limit on benefits used. In another example, certain benefits may be applied only one time (i.e., one time use benefits), while other benefits may be applied an unlimited number of times or up to a maximum number of times. In certain embodiments, the benefit limits pertain to the frequency of using benefits.

In certain embodiments, the benefit limits are additionally or alternatively associated with the amount of a transaction that attempts to apply the benefit. In certain embodiments, the benefit limits are imposed if the benefit is associated with a percentage discount. For example, a benefit, such as a discount, could be a 10% discount on dinner at any partner restaurant, but up to a $50 bill amount. In another example, a benefit, such as a discount, that offers a percentage discount may not have any purchase limit. In certain embodiments, certain retail purchases having a value above a threshold value that trigger the use of one or more benefit limits while other retail purchases that have a value below the threshold value do not trigger such benefit limits.

In certain embodiments, the benefit limits are associated with an identity of the retailer associated with a transaction that attempts to apply the benefit. In these embodiments, the system imposes, using a MCC or a whitelist or blacklist of retailers, benefit limits on a type of industry or retailer thus eliminating an entire class of retailers from participating in the program. In certain embodiments, the benefit limits are additionally or alternatively associated with the type of good and/or service associated with the transaction. In these embodiments, certain types of retail purchases trigger the use of one or more benefit limits while other types of retail purchases do not trigger such benefit limits. For example, a first category of purchases, such as food and beverage purchases, can be made without triggering any benefit limits while a second category of purchases, such as luxury retail outlets and entertainment related charges, triggers one or more benefit limits that must be satisfied before the completion of such purchases.

In certain embodiments, the benefit limits are additionally or alternatively associated with a location of the retail purchase attempted to be made that applies a benefit. In certain embodiments, the benefit limits are additionally or alternatively associated with a channel of commerce (in certain instances determined via the merchant identifier of the retail establishment) in which the transaction that attempts to apply the discount is attempted to be made.

In certain embodiments, the benefit limits are additionally or alternatively associated with a time of when the transaction that attempts to apply the benefit is attempted to be made. In certain embodiments, the benefit limits are additionally or alternatively associated with an amount of funds currently maintained in one or more accounts associated with a user. In certain embodiments, the benefit limits are additionally or alternatively associated with a current rate of consumption of the funds in one or more accounts maintained for the user. In one such embodiment, the rate of consumption is based on an amount of transactions made using funds from an account over a set period of time, such as the current day. In another such embodiment, the rate of consumption is based on an amount of transactions made using funds from an account over a rolling period of time, such as the past 24 hours.

It should be appreciated that in different embodiments, the system employs a combination of these benefit limits to determine whether or not a transaction employing the dedicated bank account that attempts to apply a benefit, such as a discount, is permitted. It should be further appreciated that in certain embodiments, one or more of the benefit limits may be overridden and/or adjusted by qualifying gaming establishment personnel and/or retail personnel. In these embodiments, the system associates different levels of overriding and/or adjusting of benefit limits with different qualifying gaming establishment personnel and/or retail personnel. In these embodiments, the system enables different levels of overriding and/or adjusting of benefit limits for different users based on one or more attributes, such as status or historical spend, of such users.

In certain embodiments, in addition to potentially approving the transfer of funds from the dedicated bank account to complete the purchase, the system communicates certain information associated with the purchase and any applicable discounts to potentially mark such discounts as used or consumed. For example, as seen in FIG. 4, following the completion of the purchase, the enterprise electronic wallet system sends certain information associated with the purchase (e.g., rating information) and the applied discount to the gaming establishment patron management system. In this example, the gaming establishment patron management system utilizes this information to update one or more records to reflect the redemption of the discount and/or determine one or more benefits in association with the purchase transaction.

In certain embodiments, the gaming establishment fund management system implements one or more usage controls, restrictions and/or security measures associated with the dedicated bank account and/or the payment instrument employed to access funds from such an account. In these embodiments, the gaming establishment fund management system is tasked with monitoring activity of the dedicated bank account, such as funding transactions, and accepting or rejecting such activity based on the currently configured limits associated with the dedicated bank account relative to certain prior activity, if any, during an applicable period of time.

It should be appreciated that in certain embodiments, since the ability to make retail purchases with funds deposited into a dedicated bank account associated with a gaming establishment account creates potential money laundering risks (e.g., a user could solely fund their account using illicit cash at an EGM, then transfer those funds back to their account and later use such funds to buy luxury goods or services from a retailer and/or a user could transfer illicit funds electronically into their account and then use such funds to make a purchase at a luxury retailer), the system of the present disclosure detects these scenarios, and potentially blocks them and/or reports them by providing the appropriate information that must be filed with financial crimes regulators in a given jurisdiction. In one such embodiment, the gaming establishment fund management system and/or enterprise electronic wallet system prevents a user from making a purchase using funds in a dedicated bank account if the funds transferred or deposited into the account have not been transferred to an EGM and/or a gambling touchpoint on a gaming establishment floor. In another such embodiment, the gaming establishment fund management system and/or enterprise electronic wallet system tracks funds that were deposited into an EGM (via cash or an instrument unaffiliated with a user, such as a ticket voucher) but were not wagered. In this embodiment, upon receipt of this information (that is, some transfer of funds into the dedicated bank account), the system restricts or prevents the user to make a purchase using such funds until those funds have been wagered with. In certain additional or alternative embodiments, one or more components of the gaming establishment fund management system and/or enterprise electronic wallet system reports on user attempts to make purchases using funds that have not been wagered. In one such embodiment, the system generates reports of all attempted retail purchases using funds in a dedicated bank account that have not been wagered over a defined lookback period. Such an embodiment enables gaming establishment personnel the ability to have the appropriate information to file one or more suspicious activity reports with financial crimes regulatory agencies, such as the US Treasury's FinCEN. In another such embodiment, upon detection of a suspicious financial transaction event, the system automatically fills in the appropriate regulatory agency report (e.g., Suspicious Activity Report (SAR), Currency Transaction Report (CTR)) for submission by the gaming establishment to the regulatory body. In another such embodiment, the system electronically submits the generated reports to the appropriate regulatory body.

As evidenced by the various embodiments described, in addition to the system of the present disclosure providing a user instant access outside of a gaming establishment to funds that would otherwise reside in a gaming establishment account for retail purposes by creating and integrating a bank account with a gaming establishment account maintained for that user, the system enables the employment of certain benefits, such as discounts, in association with the use of funds for these retail purposes. Such benefits, applied contemporaneously with the retail transaction and/or applied after a completion of the retail transaction, further incentivize the user to avail themselves of the use of a payment instrument, such as a debit card, for purchases made outside of the casino while still having funds readily available for use within the casino.

It should be appreciated that any functionality or process of the present disclosure may be implemented via one or more servers (associated with or independent of any component of any system of the present disclosure), one or more non-gaming establishment devices (e.g., a point-of-sale terminal of a retailer located external to and independent of a gaming establishment), a mobile device application, one or more gaming establishment devices (e.g., a non-gaming device such as a point-of-sale terminal of a retailer located within or otherwise associated with a gaming establishment or a gaming device such as an EGM), and/or one or more components of a gaming establishment system (such as a component of a gaming establishment management system supported by or otherwise located inside a gaming establishment device and/or a non-gaming establishment device). Accordingly: (i) while certain functions, features or processes are described herein as being performed by a non-gaming establishment device, such functions, features or processes may alternatively be performed by one or more servers, or one or more mobile device applications, one or more gaming establishment devices, and/or one or more gaming establishment components, and (ii) while certain functions, features or processes are described herein as being performed by one or more servers (e.g., a server of an enterprise electronic wallet system, a server of a gaming establishment fund management system and/or a server of a retail point-of-sale system), such functions, features or processes may alternatively be performed by one or more gaming establishment devices, one or more components of a gaming establishment system, one or more non-gaming establishment devices, one or more mobile device applications, or one or more gaming establishment components.

In certain embodiments, the above-described embodiments of the present disclosure may be implemented in accordance with or in conjunction with zero, one or more components of a gaming establishment fund management system (e.g., a cashless wagering system or a gaming establishment retail system); zero, one or more components of an enterprise electronic wallet system; zero, one or more components of a gaming establishment patron management system; zero, one or more components of a retail point-of-sale system; and/or zero, one or more gaming establishment devices. In these embodiments, such components of the gaming establishment fund management system, the enterprise electronic wallet system, the gaming establishment patron management system, the retail point-of-sale system and/or the gaming establishment device each include a controller including at least one processor.

The at least one processor is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or fund information) via a communication interface of the controller; (2) converting signals read by an interface to a format corresponding to that used by software or memory of the component of the gaming establishment fund management system, the component of the enterprise electronic wallet system, the component of the retail point-of-sale system and/or the gaming establishment device; (3) accessing memory to configure or reconfigure parameters in the memory according to indicia read from the component of the gaming establishment fund management system, the component of the enterprise electronic wallet system, the component of the retail point-of-sale system and/or the gaming establishment device; (4) communicating with interfaces and the peripheral devices (such as input/output devices); and/or (5) controlling the peripheral devices. In certain embodiments, one or more components of the controller (such as the at least one processor) reside within a housing of the component of the gaming establishment fund management system, the component of the enterprise electronic wallet system, the component of the retail point-of-sale system and/or the gaming establishment device, while in other embodiments, at least one component of the controller resides outside of the housing of the component of the gaming establishment fund management system, the component of the enterprise electronic wallet system, the component of the retail point-of-sale system and/or the gaming establishment device.

The controller also includes at least one memory device, which includes: (1) volatile memory (e.g., RAM which can include non-volatile RAM, magnetic RAM, ferroelectric RAM, and any other suitable forms); (2) non-volatile memory (e.g., disk memory, FLASH memory, EPROMs, EEPROMs, memristor-based non-volatile solid-state memory, etc.); (3) unalterable memory (e.g., EPROMs); (4) read-only memory; and/or (5) a secondary memory storage device, such as a non-volatile memory device, configured to store software related information (the software related information and the memory may be used to store various files not currently being used and invoked in a configuration or reconfiguration). Any other suitable magnetic, optical, and/or semiconductor memory may operate in conjunction with the component of the gaming establishment fund management system, the component of the enterprise electronic wallet system, the component of the retail point-of-sale system and/or the gaming establishment device disclosed herein. In certain embodiments, the at least one memory device resides within the housing of the component of the gaming establishment fund management system, the component of the enterprise electronic wallet system, the component of the retail point-of-sale system and/or the gaming establishment device, while in other embodiments at least one component of the at least one memory device resides outside of the housing of the component of the gaming establishment fund management system, the component of the enterprise electronic wallet system, the component of the retail point-of-sale system and/or the gaming establishment device. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device is configured to store, for example: (1) configuration software, such as all the parameters and settings on the component of the gaming establishment fund management system, the component of the enterprise electronic wallet system, the component of the retail point-of-sale system and/or the gaming establishment device; (2) associations between configuration indicia read from the component of the gaming establishment fund management system, the component of the enterprise electronic wallet system, the component of the retail point-of-sale system and/or the gaming establishment device with one or more parameters and settings; (3) communication protocols configured to enable the at least one processor to communicate with the peripheral devices; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the component of the gaming establishment fund management system, the component of the enterprise electronic wallet system, the component of the retail point-of-sale system and/or the gaming establishment device to communicate with local and non-local devices using such protocols. In one implementation, the controller communicates with other devices using a serial communication protocol. A few non-limiting examples of serial communication protocols that other devices, such as peripherals (e.g., a bill validator or a ticket printer), may use to communicate with the controller include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device is configured to store program code and instructions executable by the at least one processor of the component of the gaming establishment fund management system, the component of the enterprise electronic wallet system, the component of the retail point-of-sale system and/or the gaming establishment device to control the component of the gaming establishment fund management system, the component of the enterprise electronic wallet system, the component of the retail point-of-sale system and/or the gaming establishment device. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a retail patron uses such a removable memory device in a component of the gaming establishment fund management system to implement at least part of the present disclosure. In other embodiments, part or all of the program code and/or the operating data is downloaded to the at least one memory device of the component of the gaming establishment fund management system, the component of the enterprise electronic wallet system, the component of the retail point-of-sale system and/or the gaming establishment device through any suitable data network described above (such as an Internet or intranet).

The at least one memory device also stores a plurality of device drivers. Examples of different types of device drivers include device drivers for the component of the gaming establishment fund management system, the component of the enterprise electronic wallet system, the component of the retail point-of-sale system and/or the gaming establishment device and device drivers for the peripheral components. Typically, the device drivers utilize various communication protocols that enable communication with a particular physical device. The device driver abstracts the hardware implementation of that device. For example, a device driver may be written for each type of card reader that could potentially be connected to the component of the gaming establishment fund management system, the component of the enterprise electronic wallet system, the component of the retail point-of-sale system and/or the gaming establishment device. Non-limiting examples of communication protocols used to implement the device drivers include Netplex, USB, Serial, Ethernet, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the component of the gaming establishment fund management system, the component of the enterprise electronic wallet system, the component of the retail point-of-sale system and/or the gaming establishment device loads the new device driver from the at least one memory device to enable communication with the new device. For instance, one type of card reader in the component of the gaming establishment fund management system, the component of the enterprise electronic wallet system, the component of the retail point-of-sale system and/or the gaming establishment device can be replaced with a second different type of card reader when device drivers for both card readers are stored in the at least one memory device.

In certain embodiments, the software units stored in the at least one memory device can be upgraded as needed. For instance, when the at least one memory device is a hard drive, new parameters, new settings for existing parameters, new settings for new parameters, new device drivers, and new communication protocols can be uploaded to the at least one memory device from the controller or from some other external device. As another example, when the at least one memory device includes a CD/DVD drive including a CD/DVD configured to store options, parameters, and settings, the software stored in the at least one memory device can be upgraded by replacing a first CD/DVD with a second CD/DVD. In yet another example, when the at least one memory device uses flash memory or EPROM units configured to store options, parameters, and settings, the software stored in the flash and/or EPROM memory units can be upgraded by replacing one or more memory units with new memory units that include the upgraded software. In another embodiment, one or more of the memory devices, such as the hard drive, may be employed in a software download process from a remote software server.

In some embodiments, the at least one memory device also stores authentication and/or validation components configured to authenticate/validate specified components of the component of the gaming establishment fund management system, the component of the enterprise electronic wallet system, the component of the retail point-of-sale system and/or the gaming establishment device and/or information, such as hardware components, software components, firmware components, peripheral device components, user input device components, information received from one or more user input devices, information stored in the at least one memory device, etc.

In certain embodiments, the peripheral devices include several device interfaces, such as, but not limited to: (1) at least one output device including at least one display device; (2) at least one input device (which may include contact and/or non-contact interfaces); (3) at least one transponder; (4) at least one wireless communication component; (5) at least one wired/wireless power distribution component; (6) at least one sensor; (7) at least one data preservation component; (8) at least one motion/gesture analysis and interpretation component; (9) at least one motion detection component; (10) at least one portable power source; (11) at least one geolocation module; (12) at least one user identification module; (13) at least one user/device tracking module; and (14) at least one information filtering module.

The at least one output device includes at least one display device configured to display any suitable information. In certain embodiments, the display devices are connected to or mounted on a housing of the component of the gaming establishment fund management system, the component of the enterprise electronic wallet system, the component of the retail point-of-sale system and/or the gaming establishment device. In various embodiments, the display devices serve as digital glass configured to aspects of the gaming establishment in which the component of the gaming establishment fund management system, the component of the enterprise electronic wallet system, the component of the retail point-of-sale system and/or the gaming establishment device is located. In various embodiments, the component of the gaming establishment fund management system, the component of the enterprise electronic wallet system, the component of the retail point-of-sale system and/or the gaming establishment device includes zero, one or more of the following display devices: (a) a central display device; (b) a player tracking display configured to display various information regarding a user's player tracking status; (c) a secondary or upper display device in addition to the central display device and the player tracking display; (d) a credit display configured to display a current quantity of credits, amount of cash, account balance, or the equivalent; and (e) a bet display. In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

In various embodiments, the at least one output device includes a payout device. In these embodiments, after the component of the gaming establishment fund management system, the component of the enterprise electronic wallet system, the component of the retail point-of-sale system and/or the gaming establishment device receives an actuation, the component of the gaming establishment fund management system, the component of the enterprise electronic wallet system, the component of the retail point-of-sale system and/or the gaming establishment device causes the payout device to provide a payment to the user. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. In certain embodiments, rather than dispensing bills, coins, or a physical ticket having a monetary value to the user following receipt of an actuation of the cashout device, the payout device is configured to cause a payment to be provided to the user in the form of an electronic funds transfer, such as via a direct deposit into a bank account, a casino account, or a prepaid account of the user; via a transfer of funds onto an electronically recordable identification card or smart card of the user; or via sending a virtual ticket having a monetary value to an electronic device of the user.

In certain embodiments, the at least one output device is a sound generating device controlled by one or more sound cards. In one such embodiment, the sound generating device includes one or more speakers or other sound generating hardware and/or software configured to generate sounds, such as by playing music. In another such embodiment, the component of the gaming establishment fund management system, the component of the enterprise electronic wallet system, the component of the retail point-of-sale system and/or the gaming establishment device provides dynamic sounds coupled with attractive multimedia images displayed on one or more of the display devices to provide an audio-visual representation or to otherwise display full-motion video with sound to attract users to the component of the gaming establishment fund management system, the component of the enterprise electronic wallet system, the component of the retail point-of-sale system and/or the gaming establishment device. In certain embodiments, the component of the gaming establishment fund management system, the component of the enterprise electronic wallet system, the component of the retail point-of-sale system and/or the gaming establishment device displays a sequence of audio and/or visual attraction messages during idle periods to attract potential users to the component of the gaming establishment fund management system, the component of the enterprise electronic wallet system, the component of the retail point-of-sale system and/or the gaming establishment device. The videos may be customized to provide any appropriate information.

The at least one input device may include any suitable device that enables an input signal to be produced and received by the at least one processor of the component of the gaming establishment fund management system, the component of the enterprise electronic wallet system, the component of the retail point-of-sale system and/or the gaming establishment device. In one embodiment, the at least one input device includes a payment device configured to communicate with the at least one processor of the component of the gaming establishment fund management system, the component of the enterprise electronic wallet system, the component of the retail point-of-sale system and/or the gaming establishment device to fund the component of the gaming establishment fund management system, the component of the enterprise electronic wallet system, the component of the retail point-of-sale system and/or the gaming establishment device. In certain embodiments, the payment device includes zero, one or more of: (a) a bill acceptor into which paper money is inserted; (b) a ticket acceptor into which a ticket or a voucher is inserted; (c) a reader or a validator for credit cards, debit cards, or credit slips into which a credit card, debit card, or credit slip is inserted; (d) a player identification card reader into which a player identification card is inserted; or (e) any suitable combination thereof. In one embodiment, the at least one input device includes a payment device configured to enable the component of the gaming establishment fund management system, the component of the enterprise electronic wallet system, the component of the retail point-of-sale system and/or the gaming establishment device to be funded via an electronic funds transfer, such as a transfer of funds from a bank account. In another embodiment, the component of the gaming establishment fund management system, the component of the enterprise electronic wallet system, the component of the retail point-of-sale system and/or the gaming establishment device includes a payment device configured to communicate with a mobile device of a user, such as a mobile phone, a radio frequency identification tag, or any other suitable wired or wireless device, to retrieve relevant information associated with that user to fund the component of the gaming establishment fund management system, the component of the enterprise electronic wallet system, the component of the retail point-of-sale system and/or the gaming establishment device. When the component of the gaming establishment fund management system, the component of the enterprise electronic wallet system, the component of the retail point-of-sale system and/or the gaming establishment device is funded, the at least one processor determines the amount of funds entered and displays the corresponding amount.

In various embodiments, the at least one input device includes a plurality of buttons that are programmable by the component of the gaming establishment fund management system, the component of the enterprise electronic wallet system, the component of the retail point-of-sale system and/or the gaming establishment device operator to, when actuated, cause the component of the gaming establishment fund management system, the component of the enterprise electronic wallet system, the component of the retail point-of-sale system and/or the gaming establishment device to perform particular functions. For instance, such buttons may be hard keys, programmable soft keys, or icons icon displayed on a display device of the component of the gaming establishment fund management system, the component of the enterprise electronic wallet system, the component of the retail point-of-sale system and/or the gaming establishment device that are actuatable via a touch screen of the component of the gaming establishment fund management system, the component of the enterprise electronic wallet system, the component of the retail point-of-sale system and/or the gaming establishment device or via use of a suitable input device of the component of the gaming establishment fund management system, the component of the enterprise electronic wallet system, the component of the retail point-of-sale system and/or the gaming establishment device. In certain embodiments, the at least one input device includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the component of the gaming establishment fund management system, the component of the enterprise electronic wallet system, the component of the retail point-of-sale system and/or the gaming establishment device by touching the touch screen at the appropriate locations.

The at least one wireless communication component includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID);
infrared; and Near Field Magnetic communication protocols. The at least one wireless communication component transmits electrical, electromagnetic, or optical signals that carry digital data streams or analog signals representing various types of information.

The at least one wired/wireless power distribution component includes components or devices that are configured to provide power to other devices. For example, in one embodiment, the at least one power distribution component includes a magnetic induction system that is configured to provide wireless power to one or more user input devices near the component of the gaming establishment fund management system, the component of the enterprise electronic wallet system, the component of the retail point-of-sale system and/or the gaming establishment device. In one embodiment, a user input device docking region is provided, and includes a power distribution component that is configured to recharge a user input device without requiring metal-to-metal contact. In one embodiment, the at least one power distribution component is configured to distribute power to one or more internal components of the component of the gaming establishment fund management system, the component of the enterprise electronic wallet system, the component of the retail point-of-sale system and/or the gaming establishment device, such as one or more rechargeable power sources (e.g., rechargeable batteries) located at the component of the gaming establishment fund management system, the component of the enterprise electronic wallet system, the component of the retail point-of-sale system and/or the gaming establishment device.

In certain embodiments, the at least one sensor includes at least one of: optical sensors, pressure sensors, RF sensors, infrared sensors, image sensors, thermal sensors, and biometric sensors. The at least one sensor may be used for a variety of functions, such as: detecting movements and/or gestures of various objects within a predetermined proximity to the component of the gaming establishment fund management system, the component of the enterprise electronic wallet system, the component of the retail point-of-sale system and/or the gaming establishment device; detecting the presence and/or identity of various persons (e.g., users, casino employees, etc.), devices (e.g., user input devices), and/or systems within a predetermined proximity to the component of the gaming establishment fund management system, the component of the enterprise electronic wallet system, the component of the retail point-of-sale system and/or the gaming establishment device.

The at least one data preservation component is configured to detect or sense one or more events and/or conditions that, for example, may result in damage to the component of the gaming establishment fund management system, the component of the enterprise electronic wallet system, the component of the retail point-of-sale system and/or the gaming establishment device and/or that may result in loss of information associated with the component of the gaming establishment fund management system, the component of the enterprise electronic wallet system, the component of the retail point-of-sale system and/or the gaming establishment device. Additionally, the data preservation system may be operable to initiate one or more appropriate action(s) in response to the detection of such events/conditions.

The at least one motion/gesture analysis and interpretation component is configured to analyze and/or interpret information relating to detected user movements and/or gestures to determine appropriate user input information relating to the detected user movements and/or gestures. For example, in one embodiment, the at least one motion/gesture analysis and interpretation component is configured to perform one or more of the following functions: analyze the detected gross motion or gestures of a user; interpret the user's motion or gestures (e.g., in the context of a casino game being played) to identify instructions or input from the user; utilize the interpreted instructions/input to advance the game state; etc. In other embodiments, at least a portion of these additional functions may be implemented at a remote system or device.

The at least one portable power source enables the component of the gaming establishment fund management system, the component of the enterprise electronic wallet system, the component of the retail point-of-sale system and/or the gaming establishment device to operate in a mobile environment.

The at least one geolocation module is configured to acquire geolocation information from one or more remote sources and use the acquired geolocation information to determine information relating to a relative and/or absolute position of the component of the gaming establishment fund management system, the component of the enterprise electronic wallet system, the component of the retail point-of-sale system and/or the gaming establishment device. For example, in one implementation, the at least one geolocation module is configured to receive GPS signal information for use in determining the position or location of the component of the gaming establishment fund management system, the component of the enterprise electronic wallet system, the component of the retail point-of-sale system and/or the gaming establishment device. In another implementation, the at least one geolocation module is configured to receive multiple wireless signals from multiple remote devices (e.g., component of the gaming establishment fund management system, the gaming establishment patron management system, the retail point-of-sale system and/or the gaming establishment devices, servers, wireless access points, etc.) and use the signal information to compute position/location information relating to the position or location of the component of the gaming establishment fund management system, the component of the enterprise electronic wallet system, the component of the retail point-of-sale system and/or the gaming establishment device.

The at least one user identification module is configured to determine the identity of the current user or current owner of the component of the gaming establishment fund management system, the component of the enterprise electronic wallet system, the component of the retail point-of-sale system and/or the gaming establishment device. For example, in one embodiment, the current user is required to perform a login process at the component of the gaming establishment fund management system, the component of the enterprise electronic wallet system, the component of the retail point-of-sale system and/or the gaming establishment device in order to access one or more features. Alternatively, the component of the gaming establishment fund management system, the component of the enterprise electronic wallet system, the component of the retail point-of-sale system and/or the gaming establishment device is configured to automatically determine the identity of the current user based on one or more external signals, such as an RFID tag or badge worn by the current user and that provides a wireless signal to the component of the gaming establishment fund management system, the component of the enterprise electronic wallet system, the component of the retail point-of-sale system and/or the gaming establishment device that is used to determine the identity of the current user. In at least one embodiment, various security features are incorporated into the component of the gaming establishment fund management system, the component of the enterprise electronic wallet system, the component of the retail point-of-sale system and/or the gaming establishment device to prevent unauthorized users from accessing confidential or sensitive information.

The at least one information filtering module is configured to perform filtering (e.g., based on specified criteria) of selected information to be displayed at one or more displays of the component of the gaming establishment fund management system, the component of the enterprise electronic wallet system, the component of the retail point-of-sale system and/or the gaming establishment device.

In various embodiments, the component of the gaming establishment fund management system, the component of the enterprise electronic wallet system, the component of the retail point-of-sale system and/or the gaming establishment device includes a plurality of communication ports configured to enable the at least one processor of the component of the gaming establishment fund management system, the component of the enterprise electronic wallet system, the component of the retail point-of-sale system and/or the gaming establishment device to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, the component of the gaming establishment fund management system, the component of the enterprise electronic wallet system, the component of the retail point-of-sale system and/or the gaming establishment device has a support structure, housing, or cabinet that provides support for a plurality of the input devices and the output devices of the component of the gaming establishment fund management system, the component of the enterprise electronic wallet system, the component of the retail point-of-sale system and/or the gaming establishment device.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

The invention is claimed as follows:

1. A system comprising:
a processor; and
a memory device that stores a plurality of instructions that, when executed by the processor following a purchase transaction requested against a dedicated bank account associated with a gaming establishment account, cause the processor to:
determine whether to apply any discounts in association with the purchase transaction,
responsive to a plurality of discounts being available and the determination being to apply a first discount of the plurality of discounts in association with the purchase transaction:
communicate, to a component of a retail system, data associated with the applied first discount, and
cause a first determination of whether to complete the purchase transaction to occur, the first determination being based, at least in part, on an amount of funds associated with the purchase transaction reduced by the applied first discount and an amount of funds associated with the dedicated bank account, and
responsive to the plurality of discounts being available and the determination being to apply a second, different discount of the plurality of discounts in association with the purchase transaction:
communicate, to the component of the retail system, data associated with the applied second, different discount, and
cause a second determination of whether to complete the purchase transaction to occur, the second determination being based, at least in part, on the amount of funds associated with the purchase transaction reduced by the applied second, different discount and the amount of funds associated with the dedicated bank account.

2. The system of claim 1, wherein the determination to apply the first discount is based on an input received from a user associated with the dedicated bank account.

3. The system of claim 1, wherein the determination to apply the first discount automatically occurs.

4. The system of claim 1, wherein the memory device stores a plurality of further instructions that, when executed by the processor responsive to the plurality of discounts being available and the determination being to apply the first discount and the second, different discount in association with the purchase transaction, cause the processor to communicate, to the component of the retail system, data associated with the applied first discount and the applied second discount, and cause a third determination of whether to complete the purchase transaction to occur, the third determination being based, at least in part, on the amount of funds associated with the dedicated bank account and the amount of funds associated with the purchase transaction reduced by the applied first discount and the applied second, different discount.

5. The system of claim 1, wherein the memory device stores a plurality of further instructions that, when executed by the processor responsive to the determination being not to apply any discount in association with the purchase transaction, cause the processor to cause a third determination of whether to complete the purchase transaction to occur, the third determination being based, at least in part, on the amount of funds associated with the purchase transaction and the amount of funds associated with the dedicated bank account.

6. The system of claim 1, wherein the memory device stores a plurality of further instructions that, when executed by the processor responsive to a determination to complete the purchase transaction, cause the processor to communicate an authorization of the purchase transaction to the component of the retail system.

7. The system of claim 1, wherein the memory device stores a plurality of further instructions that, when executed by the processor responsive to a determination to complete the purchase transaction, cause the processor to communicate a retail rating associated with the purchase transaction to a component of a gaming establishment system.

8. The system of claim 7, wherein the retail rating comprises at least one of an amount of fund associated with the purchase transaction, a location of the purchase transaction, an identification of a user associated with the purchase transaction, an identification of the point-of-sale terminal, a date of the purchase transaction, a time of the purchase transaction, an identification of each item associated with the purchase transaction, and an amount of funds associated with each item associated with the purchase transaction.

9. The system of claim 1, wherein the memory device stores a plurality of further instructions that, when executed by the processor responsive to a determination to complete the purchase transaction, cause the processor to communicate data associated with a redemption of any applied discount to a component of a gaming establishment system.

10. A system comprising:
a processor; and
a memory device that stores a plurality of instructions that, when executed by the processor, cause the processor to:
responsive to a plurality of discounts being available and a receipt of data associated with a purchase transaction associated with a first amount of funds that is initiated at a point-of-sale terminal in association with a dedicated bank account associated with a gaming establishment account:
select a discount from the plurality of discounts,
apply, to the purchase transaction, the selected discount, and
enable the purchase transaction to be completed for a second amount of funds that is less than the first amount of funds, and
responsive to no discounts being available and the receipt of data associated with the purchase transaction associated with the first amount of funds that is initiated at the point-of-sale terminal in association with the dedicated bank account associated with a gaming establishment account, enable the purchase transaction to be completed for the first amount of funds.

11. The system of claim 10, wherein the selection of the discount is based on an input received from a user associated with the dedicated bank account.

12. A method of operating a system, the method comprising:
following a purchase transaction requested against a dedicated bank account associated with a gaming establishment account:
determining, by a processor, whether to apply any discounts in association with the purchase transaction,
responsive to a plurality of discounts being available and the determination being to apply a first discount of the plurality of discounts in association with the purchase transaction:
communicating, to a component of a retail system, data associated with the applied first discount, and
causing, by the processor, a first determination of whether to complete the purchase transaction to occur, the first determination being based, at least in part, on an amount of funds associated with the purchase transaction reduced by the applied first discount and an amount of funds associated with the dedicated bank account, and
responsive to the plurality of discounts being available and the determination being to apply a second, different discount of the plurality of discounts in association with the purchase transaction:
communicating, to the component of the retail system, data associated with the applied second, different discount, and
causing, by the processor, a second determination of whether to complete the purchase transaction to occur, the second determination being based, at least in part, on the amount of funds associated with the purchase transaction reduced by the applied second, different discount and the amount of funds associated with the dedicated bank account.

13. The method of claim 12, wherein the determination to apply the first discount is based on an input received from a user associated with the dedicated bank account.

14. The method of claim 12, wherein the determination to apply the first discount automatically occurs.

15. The method of claim 12, further comprising, responsive to the plurality of discounts being available and the determination being to apply the first discount and the second, different discount in association with the purchase transaction, communicating, to the component of the retail system, data associated with the applied first discount and the applied second discount, and causing, by the processor, a third determination of whether to complete the purchase transaction to occur, the third determination being based, at least in part, on the amount of funds associated with the dedicated bank account and the amount of funds associated with the purchase transaction reduced by the applied first discount and the applied second, different discount.

16. The method of claim 12, further comprising, responsive to the determination being not to apply any discount in association with the purchase transaction, causing, by the processor, a third determination of whether to complete the purchase transaction to occur, the third determination being based, at least in part, on the amount of funds associated with the purchase transaction and the amount of funds associated with the dedicated bank account.

17. The method of claim 12, further comprising, responsive to a determination to complete the purchase transaction, communicating an authorization of the purchase transaction to the component of the retail system.

18. The method of claim 12, further comprising, responsive to a determination to complete the purchase transaction, communicating a retail rating associated with the purchase transaction to a component of a gaming establishment system.

19. The method of claim 18, wherein the retail rating comprises at least one of an amount of fund associated with the purchase transaction, a location of the purchase transaction, an identification of a user associated with the purchase transaction, an identification of the point-of-sale terminal, a date of the purchase transaction, a time of the purchase transaction, an identification of each item associated with the purchase transaction, and an amount of funds associated with each item associated with the purchase transaction.

20. The method of claim 12, further comprising, responsive to a determination to complete the purchase transaction, communicating data associated with a redemption of any applied discount to a component of a gaming establishment system.
